(19) United States
(12) Patent Application Publication
(10) Pub. No.: US 2025/0046862 A1
(43) Pub. Date: Feb. 6, 2025

(54) LITHIUM ION CONDUCTORS AND BATTERIES, AND METHODS OF MAKING AND USE THEREOF

(71) Applicant: Energy Exploration Technologies, Inc., Austin, TX (US)

(72) Inventors: Hailong Lyu, Austin, TX (US); Jack Kivi, Austin, TX (US); Sibo Niu, Austin, TX (US); Yutao Li, Austin, TX (US); Nicholas S. Grundish, Austin, TX (US)

(21) Appl. No.: 18/789,910

(22) Filed: Jul. 31, 2024

Related U.S. Application Data
(60) Provisional application No. 63/530,147, filed on Aug. 1, 2023.

(51) Int. Cl. H01M 10/0562; H01M 10/0525

(52) U.S. Cl. CPC H01M 10/0562; H01M 10/0525; H01M 2300/0077; H01M 2300/008

(57) ABSTRACT

The disclosed subject matter relates to lithium ion conductors and batteries (such as pseudo solid state and all solid state batteries), and methods of making and use thereof. Disclosed herein are lithium ion conductors comprising Li₁₊ₓNb₁₋ₓZrₓOX₄, wherein X is a halide; and 0≤x≤1. Also disclosed herein are methods of making and use of any of the lithium ion conductors (e.g., Formula I) disclosed herein. Also disclosed herein are devices comprising any of the lithium ion conductors disclosed herein (e.g., Formula I), such as a solid state battery.

### CROSS-REFERENCE TO RELATED APPLICATIONS

This application claims the benefit of priority to U.S. Provisional Application No. 63/530,147 filed Aug. 1, 2023, which is hereby incorporated herein by reference in its entirety.

### BACKGROUND

All-solid-state batteries are considered the next step-change to current lithium-ion batteries owing to its improvement in safety and other performance metrics such as energy density and the ability to fast-charge the battery. There has been significant improvement over the past 15-20 years in the available materials to enable this next-generation technology, namely solid-state electrolytes. However, solid-state electrolytes with improved properties and/or that can be synthesized with inexpensive precursors and manufacturing methods are still needed. The devices, methods, and systems discussed herein address these and other needs.

### SUMMARY

In accordance with the purposes of the disclosed devices, methods, and systems as embodied and broadly described herein, the disclosed subject matter relates to lithium ion conductors and batteries (such as pseudo solid state and all solid state batteries), and methods of making and use thereof.

Disclosed herein are lithium ion conductors comprising a compound of Formula I:

Li₁₊ₓNb₁₋ₓZrₓOX₄ I

wherein X is a halide (e.g., F, Cl, Br, I, or a combination thereof); and x is from greater than 0 to less than 1 (e.g., 0≤x≤1).

In some examples of Formula I, x is from 0.05 to 0.95. In some examples of Formula I, x is from 0.2 to 0.95. In some examples of Formula I, x is from 0.2 to 0.7. In some examples of Formula I, x is from 0.5 to 0.95.

In some examples of Formula I, X is Cl.

In some examples of Formula I, X is Cl and x is from 0.05 to 0.95. In some examples of Formula I, X is Cl and x is from 0.2 to 0.95. In some examples of Formula I, X is Cl and x is from 0.2 to 0.7. In some examples of Formula I, X is Cl and x is from 0.5 to 0.95.

In some examples, the lithium ion conductor comprises Li_{1.1}Nb_{0.9}Zr_{0.1}OCl₄, Li_{1.3}Nb_{0.7}Zr_{0.3}OCl₄, Li_{1.5}Nb_{0.5}Zr_{0.5}OCl₄, Li_{1.7}Nb_{0.3}Zr_{0.7}OCl₄, Li_{1.9}Nb_{0.1}Zr_{0.9}OCl₄, or a combination thereof. In some examples, the lithium ion conductor comprises Li_{1.3}Nb_{0.7}Zr_{0.3}OCl₄, Li_{1.5}Nb_{0.5}Zr_{0.5}OCl₄, Li_{1.7}Nb_{0.3}Zr_{0.7}OCl₄, Li_{1.9}Nb_{0.1}Zr_{0.9}OCl₄, or a combination thereof. In some examples, the lithium ion conductor comprises Li_{1.3}Nb_{0.7}Zr_{0.3}OCl₄, Li_{1.5}Nb_{0.5}Zr_{0.5}OCl₄, Li_{1.7}Nb_{0.3}Zr_{0.7}OCl₄, or a combination thereof.

In some examples, the lithium ion conductor has a lithium ion conductivity of from 1×10⁻⁵ SCm⁻¹ to 0.1 Scm⁻¹. In some examples, the lithium ion conductor has a lithium ion conductivity of from 0.2 to 50 mS/cm.

Also disclosed herein are methods of making any of the lithium ion conductors (e.g., Formula I) disclosed herein. In some examples, the method comprises a mechanochemical synthesis.

In some examples, the method comprises combining a plurality of precursors to form a mixture and ball milling the mixture to form the lithium ion conductor. In some examples, the plurality of precursors comprise a niobium halide, a zirconium halide, and lithium hydroxide. In some examples, the plurality of precursors comprise NbCl₅, ZrCl₄, and LiOH.

In some examples, the method comprises a two-step ball-milling method. In some examples, the two-step method comprises a first step followed by a second step, and the first step comprises planetary ball-milling and the second step comprises high-energy ball milling.

In some examples, the methods further comprise a post synthesis thermal treatment, for example to improve the crystallinity of the lithium ion conductor.

Also disclosed herein are systems comprising any of the lithium ion conductors disclosed herein (e.g., Formula I).

Also disclosed herein are articles comprising any of the lithium ion conductors disclosed herein (e.g., Formula I).

Also disclosed herein are device comprising any of the lithium ion conductors disclosed herein (e.g., Formula I). In some examples, the device is an energy storage device, such as a battery. In some examples, the device is a battery, such as a solid state battery.

Also disclosed herein are solid state batteries comprising: a halide solid state electrolyte layer, the halide solid state electrolyte layer being a layer comprising a first halide solid state electrolyte, wherein the first halide solid state electrolyte is any of the lithium ion conductors disclosed herein (e.g., Formula I); and a composite cathode. The halide solid state electrolyte layer is disposed on and in contact with the composite cathode. The composite cathode comprises a cathode active material, a conductive additive, and an electrolyte; wherein the electrolyte comprises: a plurality of particles comprising a second halide solid state electrolyte; or a liquid electrolyte, a polymer electrolyte, and/or a gel electrolyte. In some examples, the solid state battery further comprises an anode, wherein the halide solid state electrolyte layer is sandwiched between and in contact with the anode and the composite cathode.

Also disclosed herein are solid state batteries comprising: an anode; a halide solid state electrolyte layer, the halide solid state electrolyte layer being a layer comprising a first halide solid state electrolyte, wherein the first halide solid state electrolyte is any of the lithium ion conductors disclosed herein (e.g., Formula I); and a composite cathode. The halide solid state electrolyte layer is sandwiched between and in contact with the anode and the composite cathode. The composite cathode comprises a cathode active material, a conductive additive, and an electrolyte; wherein the electrolyte comprises: a plurality of particles comprising a second halide solid state electrolyte; or a liquid electrolyte, a polymer electrolyte, and/or a gel electrolyte. In some examples, the lithium ion conductor comprises Li₁₊ₓNb₁₋ₓZrₓOX₄, wherein X is a halide (e.g., F, Cl, Br, I, or a combination thereof) and x is from 0.2 to 0.7. In some examples, X is Cl.

In some examples, the solid state battery further comprises an interfacial layer comprising an interfacial material. The interfacial layer is sandwiched between and in contact with the anode and the halide solid state electrolyte layer. The halide solid state electrolyte layer is sandwiched between and in contact with the interfacial layer and the composite cathode. The anode, the interfacial layer, the halide solid state electrolyte layer, and the composite cathode each has an electrochemical stability window; and the electrochemical stability window of the interfacial layer overlaps with that of the halide solid state electrolyte layer and the anode.

Also disclosed herein are solid state batteries comprising: an anode; an interfacial layer comprising an interfacial material; a halide solid state electrolyte layer, the halide solid state electrolyte layer being a layer comprising a first halide solid state electrolyte, wherein the first halide solid state electrolyte is any of the lithium ion conductors disclosed herein (e.g., Formula I); and a composite cathode. The interfacial layer is sandwiched between and in contact with the anode and the halide solid state electrolyte layer. The halide solid state electrolyte layer is sandwiched between and in contact with the interfacial layer and the composite cathode. The anode, the interfacial layer, the halide solid state electrolyte layer, and the composite cathode each has an electrochemical stability window; wherein the electrochemical stability window of the interfacial layer overlaps with that of the halide solid state electrolyte layer and the anode.

The composite cathode comprises a cathode active material, a conductive additive, and an electrolyte; wherein the electrolyte comprises: a plurality of particles comprising a second halide solid state electrolyte; or a liquid electrolyte, a polymer electrolyte, and/or a gel electrolyte. In some examples, the lithium ion conductor comprises Li₁₊ₓNb₁₋ₓZrₓOX₄, wherein X is a halide (e.g., F, Cl, Br, I, or a combination thereof) and x is from 0.5 to 0.95. In some examples, X is Cl.

In some examples, the interfacial layer has an average thickness of from 1 nanometer (nm) to 100 micrometers (microns, μm). In some examples, the interfacial layer has an average thickness of from 100 nanometers (nm) to 20 micrometers (microns, μm).

In some examples, the interfacial layer has an ionic conductivity of lithium of from 1×10⁻⁸ Scm⁻¹ to 0.1 Scm⁻¹.

In some examples, the interfacial material comprises Li₆PS₅X (where X is Cl, Br, or I), Li₇P₃S₁₁ (LPS), garnet Li₇La₃Zr₂O₁₂ (LLZO), Li₃ₓLa_{2/3-x}TiO₃ (lithium lanthanum titanate (LLTO) perovskite), Li₃N, Li₃P, Li₃PS₄, LiBH₄, Li₂₊₂ₓZn₁₋ₓGeO₄, Li₁₊ₓAlₓTi₂₋ₓ(PO₄)₃ (LATP), Li₁₊ₓAlₓGe₂₋ₓ(PO₄)₃ (LAGP), Li₁₀GeP₂S₁₂ (LGPS), derivatives thereof (e.g., doped versions thereof), or a combination thereof. In some examples, the interfacial material comprises Li₆PS₅Cl (LPSCl), Li₇P₃S₁₁ (LPS), garnet Li₇La₃Zr₂O₁₂ (LLZO), Li₃N, Li₃PS₄, Li₃P, or a combination thereof. In some examples, the interfacial material comprises Li₆PS₅Cl (LPSCl), Li₇P₃S₁₁ (LPS), garnet Li₇La₃Zr₂O₁₂ (LLZO), Li₃PS₄, or a combination thereof.

In some examples, the interfacial material comprises Li₆PS₅Cl (LPSCl).

In some examples, the interfacial layer comprises a plurality of particles of the interfacial material. In some examples, the plurality of particles of the interfacial material have an average particle size of from 1 nanometer (nm) to 25 micrometers (microns, μm). In some examples, the plurality of particles of the interfacial material have an average particle size of from 100 nanometers (nm) to 10 micrometers (microns, μm).

In some examples, the anode is formed in situ.

In some examples, the anode has a high capacity and/or a high energy density. In some examples, the anode has a specific capacity of from 100 to 4000 mAh/g.

In some examples, the anode has a low intercalation voltage. In some examples, the anode has an intercalation voltage of as 1 V or less versus Li⁺/Li⁰.

In some examples, the anode comprises a metal, an alloy, an intercalation material, or a combination thereof. In some examples, the anode comprises lithium silicon, indium, graphite, hard carbon, or a combination thereof.

In some examples, the anode comprises lithium (e.g., lithium metal and/or a lithium alloy). In some examples, the anode comprises lithium metal. In some examples, the anode comprises a lithium alloy. In some examples, the anode comprises a lithium-indium alloy, a lithium-magnesium alloy, a lithium-aluminum alloy, a lithium-iron alloy, or a combination thereof. In some examples, the anode comprises a lithium-indium alloy.

In some examples, the anode comprises a composite (e.g., the anode is a composite anode).

In some examples, the composite anode further includes a binder. In some examples, the binder comprises a polyethylene oxide (PEO), polyvinylidene fluoride (PVDF), polytetrafluoroethylene (PTFE), cellulose, carboxymethylcellulose (CMC), styrene-butadiene rubber (SBR), polyacrylic acid (PAA), polyvinyl alcohol (PVA), polyvinyl butyral (PVB), polyvinylpyrrolidone (PVP), ethyl cellulose (EC), copolymers thereof, derivatives thereof, or a combination thereof.

In some examples, the composite anode further includes a conductive additive. In some examples, the conductive additive comprises a carbon black, a modified carbon black, a graphene, a multi-layer graphene, carbon fibers, carbon nanotubes, carbon nanospheres, graphite, a reduced graphene oxide, or a combination thereof. In some examples, the conductive additive comprises carbon black.

In some examples, the anode comprises a prelithiated host structure (e.g., a prelithiated silicon anode, a prelithiated silicon-graphite composite anode, a prelithiated graphite, a prelithiated hard carbon, etc.), a silicon-graphite composite anode, or a combination thereof.

In some examples, the halide solid state electrolyte layer has an average thickness of from 1 to 100 micrometers (microns, μm).

In some examples, the halide solid state electrolyte layer comprises a plurality of particles of the first halide solid state electrolyte. In some examples, the plurality of particles of the first halide solid state electrolyte have an average particle size of from 1 nanometer (nm) to 100 micrometers (microns, μm). In some examples, the plurality of particles of the first halide solid state electrolyte have an average particle size of from 100 nanometers to 20 micrometers.

In some examples, the electrochemical stability window of the halide solid state electrolyte is compatible with the electrochemical stability window of the composite cathode.

In some examples, the cathode active material comprises a high density nickel-rich layered transition metal oxide (e.g., Li[NiₓMn_{y}Co_{z}]O₂ (x+y+z=1)), LiFe₁₋ₓMnₓPO₄ (LMFP), a lithium iron phosphate (LFP, LiFePO₄), lithium manganese oxide (LiMn₂O₄), nickel-doped lithium manganese oxide (Li[Ni_{0.5}Mn_{1.5}]O₄), LiCoO₂, LiNiO₂, or a combination thereof. In some examples, the cathode active material comprises Li[NiₓMn_{y}Co_{z}]O₂ where x+y+z=1, LiFePO₄, or a combination thereof.

In some examples, the conductive additive of the composite cathode comprises a carbon black, a modified carbon black, a graphene, a multi-layer graphene, carbon fibers, carbon nanotubes, carbon nanospheres, graphite, a reduced graphene oxide, or a combination thereof. In some examples, the conductive additive of the composite cathode comprises carbon black.

In some examples, the composite cathode further comprises a binder. In some examples, the binder comprises a polyethylene oxide (PEO), polyvinylidene fluoride (PVDF), polytetrafluoroethylene (PTFE), cellulose, carboxymethylcellulose (CMC), styrene-butadiene rubber (SBR), polyacrylic acid (PAA), polyvinyl alcohol (PVA), polyvinyl butyral (PVB), polyvinylpyrrolidone (PVP), ethyl cellulose (EC), copolymers thereof, derivatives thereof, or a combination thereof.

In some examples, the solid state battery is an all solid state battery. In some examples, the electrolyte of the composite cathode is a plurality of particles comprising a second halide solid state electrolyte.

In some examples, the second halide solid state electrolyte has an ionic conductivity of lithium of from 1×10⁻⁶ SCm⁻¹ to 1 SCm⁻¹.

In some examples, the second halide solid state electrolyte comprises a lithium halide, a sodium halide, or a combination thereof. In some examples, the second halide solid state electrolyte comprises a lithium halide. In some examples, the second halide solid state electrolyte comprises any of the lithium ion conductors disclosed herein (e.g., Formula I). In some examples, the second halide solid state electrolyte comprises Li_{3-z}M^{[III+z]}X₆, where X is one or more halides, z is an integer from −2 to 2, and [III+z] represents the valence of the M-ion(s) in the compound. In some examples, the second halide solid state electrolyte and the first halide solid state electrolyte are the same. In some examples, the second halide solid state electrolyte and the first halide solid state electrolyte are different.

In some examples, the plurality of particles of second halide solid state electrolyte have an average particle size of from 1 nanometer (nm) to 50 micrometers (microns, μm). In some examples, the plurality of particles of second halide solid state electrolyte have an average particle size of from 100 nanometers to 20 micrometers. In some examples, the average particle size of the plurality of particles of the first halide solid state electrolyte and the average particle size of the plurality of particles of the second halide solid state electrolyte are the same. In some examples, the average particle size of the plurality of particles of the first halide solid state electrolyte and the average particle size of the plurality of particles of the second halide solid state electrolyte are different.

In some examples, the solid state battery is a pseudo solid state battery. In some examples, the electrolyte of the composite cathode is a liquid electrolyte, a polymer electrolyte, and/or a gel electrolyte.

In some examples, the solid state battery further comprises a first current collector. When the anode is present, the anode is sandwiched between and in contact with the first current collector and the interfacial layer (when present) or the halide solid state electrolyte layer (when the interfacial layer is absent). When the anode is absent, the first current collector is in contact with the interfacial layer (when present) or the halide solid state electrolyte layer (when the interfacial layer is absent).

In some examples, the solid state battery further comprises a second current collector, wherein the cathode is sandwiched between and in contact with the second current collector and the halide solid state electrolyte layer.

In some examples, the first current collector and/or the second current collector (when present) independently comprise a metal, a carbon material, or a combination thereof.

In some examples, the solid state battery further includes a casing that at least partially surrounds and/or encloses a cell comprising the anode (when present), the interfacial layer (when present), the halide solid state electrolyte layer, the composite cathode, the first current collector (when present), and the second current collector (when present). In some examples, the casing comprises a polymer, a metal, an alloy, a polymer coated metal foil, or a combination thereof.

In some examples, the anode is substantially free of dendrites during a plating/stripping cycle of operation of the solid state battery.

In some examples, the interfacial layer is substantially free of dendrites during a plating/stripping cycle of operation of the solid state battery.

In some examples, the solid state battery exhibits an energy density of from 75 Wh/kg to 600 Wh/kg.

In some examples, the solid state battery exhibits a specific discharge capacity of from 100 mA h/g to 400 mA h/g when discharged at a rate of from 0.1 C to 10 C.

In some examples, the solid state battery is rechargeable.

In some examples, the solid state battery exhibits a coulombic efficiency of 80% or more for 100 cycles or more. In some examples, the solid state battery exhibits a coulombic efficiency of 99% or more for 100 cycles or more.

In some examples, the solid state battery exhibits a capacity retention of 80% or more for 100 cycles or more. In some examples, the solid state battery exhibits a capacity retention of 90% or more for 100 cycles or more.

Also disclosed herein are methods of making any of the solid state batteries disclosed herein. In some examples, the method comprises a dry chemical process in which the cathode and anode (when present) are produced separately and the halide solid state electrolyte material and the interfacial layer (when present) are produced as freestanding films or membranes and the entire cell is sandwiched together.

Also disclosed herein are systems comprising one or more of the solid state batteries disclosed herein. In some examples, the system is an energy storage system.

Also disclosed herein are articles comprising one or more of the solid state batteries disclosed herein. In some examples, the article is a vehicle, such as a hybrid electric vehicle or an all-electric vehicle. In some examples, the article comprises an electronic device, such as a portable electronic device, a laptop, a watch, or a cell phone.

Additional advantages of the disclosed devices, systems, and methods will be set forth in part in the description which follows, and in part will be obvious from the description. The advantages of the disclosed devices, systems, and methods will be realized and attained by means of the elements and combinations particularly pointed out in the appended claims. It is to be understood that both the foregoing general description and the following detailed description are exemplary and explanatory only and are not restrictive of the disclosed devices, systems, and methods, as claimed.

The details of one or more embodiments of the invention are set forth in the accompanying drawings and the description below. Other features, objects, and advantages of the invention will be apparent from the description and drawings, and from the claims.

### BRIEF DESCRIPTION OF THE FIGURES

The accompanying figures, which are incorporated in and constitute a part of this specification, illustrate several aspects of the disclosure, and together with the description, serve to explain the principles of the disclosure.

FIG. 1 depicts electrochemical impedance spectra results of Li₁₊ₓNb₁₋ₓZrₓOCl₄ (LNZOC; x=0, 0.1, 0.3, 0.5, 0.7, 0.9, and 1.0) oxyhalide solid-state electrolyte materials at room temperature. The testing sample amount is 250 mg, which is pressed into a ˜1.35 mm thick pellet of Φ10 mm.

FIG. 2 shows the trend of ionic conductivity relative to the Zr content in the Li₁₊ₓNb₁₋ₓZrₓOCl₄ oxyhalide materials.

FIG. 3 is an optical photograph of the Li_{1.7}Nb_{0.3}Zr_{0.7}OCl₄, and Li_{1.5}Nb_{0.5}Zr_{0.5}OCl₄ materials after being in direct physical contact with lithium metal for 12 hours.

FIG. 4 depicts the cycling performance of Li/Li symmetric coin cells of Li_{1.9}Nb_{0.1}Zr_{0.9}OCl₄, Li_{1.7}Nb_{0.3}Zr_{0.7}OCl₄, and Li_{1.5}Nb_{0.5}Zr_{0.5}OCl₄ electrolyte materials with a current density of 0.05 mA/cm².

FIG. 5 depicts the cycling performance of 1-solid-state batteries in coin cell format with an LiNi_{0.8}Mn_{0.1}Co_{0.1}O₂(NMC811) cathode, LNZOC electrolyte, Li₆PS₅Cl (LPSCl) interfacial layer, and Li/In alloy anode. All the cells were tested at the current rate of C/10 under room temperature, without external pressure.

### DETAILED DESCRIPTION

The devices, methods, and systems described herein may be understood more readily by reference to the following detailed description of specific aspects of the disclosed subject matter and the Examples included therein.

Before the present devices, methods, and systems are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### General Definitions

In this specification and in the claims that follow, reference will be made to a number of terms, which shall be defined to have the following meanings.

Throughout the description and claims of this specification the word “comprise” and other forms of the word, such as “comprising” and “comprises,” means including but not limited to, and is not intended to exclude, for example, other additives, components, integers, or steps.

As used in the specification and in the claims, the term “comprising” can include the aspects “consisting of” and “consisting essentially of” As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such components, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, a description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

When the specific values are disclosed between two end values, it is understood that these end values can also be included.

For the terms “for example” and “such as,” and grammatical equivalences thereof, the phrase “and without limitation” is understood to follow unless explicitly stated otherwise. It is further understood that these phrases are used not used in a restrictive sense, but for explanatory purposes. “Exemplary” means “an example of” and is not intended to convey an indication of a preferred or ideal embodiment.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

Spatially relative terms, such as “beneath,” “below,” “lower,” “above,” “upper,” “bottom,” “top,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations), and the spatially relative descriptors used herein are interpreted accordingly.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”).

As used herein, the term “and/or” includes any and all combinations of one or more of the associated listed items.

As used herein, the term “substantially” means that the subsequently described event or circumstance completely occurs or that the subsequently described event or circumstance generally, typically, or approximately occurs.

Still further, the term “substantially” can, in some aspects, refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is then about 1% by weight, e.g., less than about 0.5% by weight, less than about 0.1% by weight, less than about 0.05% by weight, or less than about 0.01% by weight of the stated material, based on the total weight of the composition.

The expressions “ambient temperature” and “room temperature” as used herein are understood in the art and refer generally to a temperature from about 20° C. to about 35° C.

References in the specification and concluding claims to parts by weight of a particular element or component in a composition denotes the weight relationship between the element or component and any other elements or components in the composition or article for which a part by weight is expressed. Thus, in a mixture containing 2 parts by weight of component X and 5 parts by weight, components Y, X, and Y are present at a weight ratio of 2:5 and are present in such a ratio regardless of whether additional components are contained in the mixture.

A weight percent (wt. %) of a component, unless specifically stated to the contrary, is based on the total weight of the formulation or composition in which the component is included.

It is understood that the term “salt,” as used herein, refers to a chemical compound that can be formed form a reaction between an acid and a base. It is understood that the term “salt,” as used herein, encompasses both inorganic and organic salts capable of providing the desired properties to the composition. In still further aspects, a cation of the disclosed herein salts is a metal cation.

While aspects of the present invention can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to the arrangement of steps or operational flow, plain meaning derived from grammatical organization or punctuation, or the number or type of aspects described in the specification.

Unless otherwise defined, all technical and scientific terms used herein have the same meaning as commonly understood by one of ordinary skill in the art to which this invention belongs.

The organic moieties mentioned when defining variable positions within the general formulae described herein (e.g., the term “halogen”) are collective terms for the individual substituents encompassed by the organic moiety. The prefix Cn-Cm preceding a group or moiety indicates, in each case, the possible number of carbon atoms in the group or moiety that follows.

The term “ion,” as used herein, refers to any molecule, portion of a molecule, cluster of molecules, molecular complex, moiety, or atom that contains a charge (positive, negative, or both at the same time within one molecule, cluster of molecules, molecular complex, or moiety (e.g., zwitterions)) or that can be made to contain a charge. Methods for producing a charge in a molecule, portion of a molecule, cluster of molecules, molecular complex, moiety, or atom are disclosed herein and can be accomplished by methods known in the art, e.g., protonation, deprotonation, oxidation, reduction, alkylation, acetylation, esterification, de-esterification, hydrolysis, etc.

The term “anion” is a type of ion and is included within the meaning of the term “ion.” An “anion” is any molecule, portion of a molecule (e.g., zwitterion), cluster of molecules, molecular complex, moiety, or atom that contains a net negative charge or that can be made to contain a net negative charge. The term “anion precursor” is used herein to specifically refer to a molecule that can be converted to an anion via a chemical reaction (e.g., deprotonation).

The term “cation” is a type of ion and is included within the meaning of the term “ion.” A “cation” is any molecule, portion of a molecule (e.g., zwitterion), cluster of molecules, molecular complex, moiety, or atom, that contains a net positive charge or that can be made to contain a net positive charge. The term “cation precursor” is used herein to specifically refer to a molecule that can be converted to a cation via a chemical reaction (e.g., protonation or alkylation).

The term “halide” or “halogen” or “halo” as used herein refers to fluorine, chlorine, bromine, and iodine.

### Lithium Ion Conductors

Disclosed herein are lithium ion conductors. For example, disclosed herein are lithium ion conductors comprising a compound of Formula I:

Li₁₊ₓNb₁₋ₓZrₓOX₄ I

wherein X is a halide (e.g., F, Cl, Br, I, or a combination thereof); and x is from greater than 0 to less than 1 (e.g., 0≤x≤1).

Without wishing to be bound by theory, the value of x can be selected to inclusion of the interfacial layer can improve the stability of the halide solid state electrolyte layer with an anode (e.g., lithium metal anode) while maintaining properties (e.g., ionic conductivity) that can enable an all-solid-state battery with a halide solid state electrolyte.

In some examples of Formula I, x is from 0.05 to 0.95. In some examples of Formula I, x is from 0.2 to 0.95. In some examples of Formula I, x is from 0.2 to 0.7. In some examples of Formula I, x is from 0.5 to 0.95.

In some examples of Formula I, X is Cl.

In some examples of Formula I, X is Cl and x is from 0.05 to 0.95. In some examples of Formula I, X is Cl and x is from 0.2 to 0.95. In some examples of Formula I, X is Cl and x is from 0.2 to 0.7. In some examples of Formula I, X is Cl and x is from 0.5 to 0.95.

In some examples, the lithium ion conductor comprises Li_{1.1}Nb_{0.9}Zr_{0.1}OCl₄, Li_{1.3}Nb_{0.7}Zr_{0.3}OCl₄, Li_{1.5}Nb_{0.5}Zr_{0.5}OCl₄, Li_{1.7}Nb_{0.3}Zr_{0.7}OCl₄, Li_{1.9}Nb_{0.1}Zr_{0.9}OCl₄, or a combination thereof. In some examples, the lithium ion conductor comprises Li_{1.3}Nb_{0.7}Zr_{0.3}OCl₄, Li_{1.5}Nb_{0.5}Zr_{0.5}OCl₄, Li_{1.7}Nb_{0.3}Zr_{0.7}OCl₄, Li_{1.9}Nb_{0.1}Zr_{0.9}OCl₄, or a combination thereof. In some examples, the lithium ion conductor comprises Li_{1.3}Nb_{0.7}Zr_{0.3}OCl₄, Li_{1.5}Nb_{0.5}Zr_{0.5}OCl₄, Li_{1.7}Nb_{0.3}Zr_{0.7}OCl₄, or a combination thereof.

In some examples, the lithium ion conductor has a lithium ion conductivity of 1×10⁻⁵ Scm⁻¹ or more (e.g., 5×10⁻⁵ Scm⁻¹ or more, 1×10⁻⁴ Scm⁻¹ or more, 5×10⁻⁴ SCm⁻¹ or more, 1×10⁻³ Scm⁻¹ or more, 5×10⁻³ Scm⁻¹ or more, 1×10⁻² SCm⁻¹ or more, or 5×10⁻² SCm⁻¹ or more).

In some examples, the lithium ion conductor has a lithium ion conductivity of 0.1 Scm⁻¹ or less (e.g., 5×10⁻² SCm⁻¹ or less, 1×10⁻² SCm⁻¹ or less, 5×10⁻³ Scm⁻¹ or less, 1×10⁻³ Scm⁻¹ or less, 5×10⁻⁴ Scm⁻¹ or less, 1×10⁻⁴ Scm⁻¹ or less, or 5×10⁻⁵ Scm⁻¹ or less). The lithium ion conductivity of the lithium ion conductor can range from any of the minimum values described above to any of the maximum values described above. For example, the lithium ion conductor can have a lithium ion conductivity of from 1×10⁻⁵ SCm⁻¹ to 0.1 Scm⁻¹ (e.g., from 1×10⁻⁵ to 5×10⁻³ Scm⁻¹, from 5×10⁻³ to 0.1 Scm⁻¹, from 1×10⁻⁵ to 1×10⁻⁴ SCm⁻¹, from 1×10⁻⁴ to 1×10⁻³ Scm⁻¹, from 1×10⁻³ to 1×10⁻² Scm⁻¹, from 1×10⁻² to 0.1 Scm⁻¹, from 1×10⁻⁴ to 0.1 Scm⁻¹, from 1×10⁻³ to 0.1 Scm⁻¹, or from 1×10⁻² to 0.1 Scm⁻¹). In some examples, the lithium ion conductor has a lithium ion conductivity of from 0.2 to 50 mS/cm. The ionic conductivity can be measured using methods known in the art, such as using Electrochemical Impedance Spectroscopy (EIS) and then calculated with an ionic conductivity equation.

### Methods of Making and Use of Lithium Ion Conductors

Also disclosed herein are methods of making any of the lithium ion conductors described herein. For example, the method comprises a mechanochemical synthesis.

In some examples, the method comprises combining a plurality of precursors to form a mixture and ball milling the mixture to form the lithium ion conductor. The plurality of precursors can comprise any suitable precursors, for example to prepare a lithium ion conductor of Formula I. In some examples, the plurality of precursors comprise a niobium halide, a zirconium halide, and lithium hydroxide. In some examples, the plurality of precursors comprise NbCl₅, ZrCl₄, and LiOH.

In some examples, the method comprises a two-step ball-milling method. In some examples, the two-step method comprises a first step followed by a second step, and the first step comprises planetary ball-milling and the second step comprises high-energy ball milling.

In some examples, the methods can further comprise a post synthesis thermal treatment, for example to improve the crystallinity of the lithium ion conductor.

Also disclosed herein are methods of use of any of the lithium ion conductors described herein. For example, also disclosed herein are methods of use of any of the lithium ion conductors described herein, for example in a system, an article, and/or a device.

Also disclosed herein are systems, articles, and/or devices comprising any of the lithium ion conductors disclosed herein. For example, the device can be an energy storage device, such as a battery. In some examples, the device is a battery, such as a solid state battery.

### Solid State Batteries

Disclosed herein are solid state batteries, such as pseudo solid state and all solid state batteries, comprising any of the lithium ion conductors described herein.

For example, disclosed herein are solid state batteries comprising: a halide solid state electrolyte layer, the halide solid state electrolyte layer being a layer comprising a first halide solid state electrolyte, wherein the first halide solid state electrolyte is any of the lithium ion conductors described herein (e.g., Formula I); and a composite cathode. The halide solid state electrolyte layer is disposed on and in contact with the composite cathode. In some examples, the solid state battery further comprises an anode, and the halide solid state electrolyte layer is sandwiched between and in contact with the anode and the composite cathode. In some examples, the anode is formed in situ (e.g. the anode is plated in situ during cycling).

For example, disclosed herein are solid state batteries comprising: an anode; a halide solid state electrolyte layer, the halide solid state electrolyte layer being a layer comprising a first halide solid state electrolyte, wherein the first halide solid state electrolyte is any of the lithium ion conductors described herein (e.g., Formula I); and a composite cathode. The halide solid state electrolyte layer is sandwiched between and in contact with the anode and the composite cathode.

In some examples, the solid state batteries further comprise an interfacial layer comprising an interfacial material, wherein the interfacial layer is sandwiched between and in contact with the anode and the halide solid state electrolyte layer and the halide solid state electrolyte layer is sandwiched between and in contact with the interfacial layer and the composite cathode. The anode, the interfacial layer, the halide solid state electrolyte layer, and the composite cathode each has an electrochemical stability window, and the electrochemical stability window of the interfacial layer overlaps with that of the halide solid state electrolyte layer and the anode.

Also disclosed herein are solid state batteries comprising an anode, an interfacial layer comprising an interfacial material, a halide solid state electrolyte layer, the halide solid state electrolyte layer being a layer comprising a first halide solid state electrolyte, wherein the first halide solid state electrolyte is any of the lithium ion conductors described herein (e.g., Formula I), and a composite cathode. The interfacial layer is sandwiched between and in contact with the anode and the halide solid state electrolyte layer. The halide solid state electrolyte layer is sandwiched between and in contact with the interfacial layer and the composite cathode. The anode, the interfacial layer, the halide solid state electrolyte layer, and the composite cathode each has an electrochemical stability window, and the electrochemical stability window of the interfacial layer overlaps with that of the halide solid state electrolyte layer and the anode.

### Anode

The solid state batteries disclosed herein comprise an anode. The anode can comprise any suitable material, such as those known in the art.

In some examples, the anode is formed in situ (e.g., the anode is plated in situ during cycling).

In some examples, the anode has a high capacity and/or a high energy density. For example, the anode has a specific capacity of 100 mAh/g or more (e.g., 125 mAh/g or more, 150 mAh/g or more, 175 mAh/g or more, 200 mAh/g or more, 225 mAh/g or more, 250 mAh/g or more, 300 mAh/g or more, 350 mAh/g or more, 400 mAh/g or more, 450 mAh/g or more, 500 mAh/g or more, 600 mAh/g or more, 700 mAh/g or more, 800 mAh/g or more, 900 mAh/g or more, 1000 mAh/g or more, 1250 mAh/g or more, 1500 mAh/g or more, 1750 mAh/g or more, 2000 mAh/g or more, 2250 mAh/g or more, 2500 mAh/g or more, 2750 mAh/g or more, 3000 mAh/g or more, 3250 mAh/g or more, 3500 mAh/g or more, or 3750 mAh/g or more). In some examples, the anode can have a specific capacity of 4000 mAh/g or less (e.g., 3750 mAh/g or less, 3500 mAh/g or less, 3250 mAh/g or less, 3000 mAh/g or less, 2750 mAh/g or less, 2500 mAh/g or less, 2250 mAh/g or less, 2000 mAh/g or less, 1750 mAh/g or less, 1500 mAh/g or less, 1250 mAh/g or less, 1000 mAh/g or less, 900 mAh/g or less, 800 mAh/g or less, 700 mAh/g or less, 600 mAh/g or less, 500 mAh/g or less, 450 mAh/g or less, 400 mAh/g or less, 350 mAh/g or less, 300 mAh/g or less, 250 mAh/g or less, 225 mAh/g or less, 200 mAh/g or less, 175 mAh/g or less, 150 mAh/g or less, or 125 mAh/g or less). The specific capacity of the anode can range from any of the minimum values described above to any of the maximum values described above. For example, the anode can have a specific capacity of from 100 to 4000 mAh/g (e.g., from 100 to 2000 mAh/g, from 2000 to 4000 mAh/g, from 100 to 1000 mAh/g, from 1000 to 2000 mAh/g, from 2000 to 3000 mAh/g, from 3000 to 4000 mAh/g, from 100 to 3500 mAh/g, from 100 to 3000 mAh/g, from 100 to 2500 mAh/g, from 100 to 1500 mAh/g, from 100 to 750 mAh/g, from 500 to 4000 mAh/g, from 750 to 4000 mAh/g, from 1000 to 4000 mAh/g, from 1500 to 4000 mAh/g, from 2500 to 4000 mAh/g, from 250 to 3750 mAh/g, from 500 to 3500 mAh/g, from 750 to 3250 mAh/g, or from 1000 to 3000 mAh/g). The specific capacity of the anode can be calculated and/or theoretical. The specific capacity of the anode can be measured using methods known in the art, such as in an electrochemical cell, similar to charge/discharge cycling of a battery, for example using Galvanostatic cycling.

In some examples, the anode has a low intercalation voltage. For example, the anode can have an intercalation voltage of 1 V or less versus Li⁺/Li⁰ (e.g., 0.95 V or less, 0.9 V or less, 0.85 V or less, 0.8 V or less, 0.75 V or less, 0.7 V or less, 0.65 V or less, 0.6 V or less, 0.55 V or less, 0.5 V or less, 0.45 V or less, 0.4 V or less, 0.35 V or less, 0.3 V or less, 0.25 V or less, 0.2 V or less, 0.15 V or less, 0.1 V or less, or 0.05 V or less).

In some examples, the anode comprises a metal, an alloy, an intercalation material, or a combination thereof. For example, the anode can comprise lithium, silicon, indium, graphite, hard carbon, or a combination thereof.

In some examples, the anode comprises lithium (e.g., lithium metal and/or a lithium alloy). In some examples, the anode comprises lithium metal. In some examples, the anode comprises a lithium alloy. In some examples, the anode comprises a lithium-indium alloy, a lithium-magnesium alloy, a lithium-aluminum alloy, a lithium-iron alloy, or a combination thereof. In some examples, the anode comprises a lithium-indium alloy.

In some examples, the anode comprises lithium metal. In some examples, the anode comprises a lithium alloy. In some examples, the anode comprises a lithium-indium alloy.

In some examples, the anode is a composite (e.g., a composite anode).

In some examples, the composite anode further includes a binder. Examples of suitable binders are known in the art. For example, the binder can comprise a polyethylene oxide (PEO), polyvinylidene fluoride (PVDF), polytetrafluoroethylene (PTFE), cellulose, carboxymethylcellulose (CMC), styrene-butadiene rubber (SBR), polyacrylic acid (PAA), polyvinyl alcohol (PVA), polyvinyl butyral (PVB), polyvinylpyrrolidone (PVP), ethyl cellulose (EC), copolymers thereof, derivatives thereof, or a combination thereof.

In some examples, the composite anode further includes a conductive additive. The conductive additive can comprise any suitable material, such as those known in the art. Examples of suitable conductive additives include, but are not limited to, carbon black, modified carbon black, graphene, multi-layer graphene, carbon fibers, carbon nanotubes, carbon nanospheres, graphite, reduced graphene oxide, and combinations thereof. In some examples, the conductive additive comprises carbon black.

In some examples, the anode comprises a prelithiated host structure anode (e.g., a prelithiated silicon anode, a prelithiated silicon-graphite composite anode, a prelithiated graphite, a prelithiated hard carbon, etc.), a silicon-graphite composite anode, or a combination thereof.

### Interfacial Layer

In some examples, the solid state batteries disclosed herein further comprise an interfacial layer.

Without wishing to be bound by theory, the inclusion of the interfacial layer can overcome the instability of the halide solid state electrolyte layer with the anode (e.g., lithium metal anode) to enable an all-solid-state battery with a halide solid state electrolyte. For example, the integration of the interfacial layer between the halide solid state electrolyte and the anode can stabilize the interface for extended duration and plating/stripping of the anode.

The interfacial layer can comprise any suitable material. For example, the interfacial layer can comprise any material such that the electrochemical stability window of the interfacial layer overlaps with that of the halide solid state electrolyte layer and the anode. In some examples, the interfacial layer can comprise a material that is compatible with the halide solid state electrolyte layer and the anode.

Examples of suitable interfacial materials include, but are not limited to, Li₆PS₅X (where X is Cl, Br, or I), Li₇P₃S₁₁ (LPS), garnet Li₇La₃Zr₂O₁₂ (LLZO), Li₃ₓLa_{2/3-x}TiO₃ (lithium lanthanum titanate (LLTO) perovskite), Li₃N, Li₃P, Li₃PS₄, LiBH₄, Li₂₊₂ₓZn₁₋ₓGeO₄, Li₁₊ₓAlₓTi₂₋ₓ(PO₄)₃(LATP), Li₁₊ₓAlₓGe₂₋ₓ(PO₄)₃(LAGP), Li₁₀GeP₂Si₂ (LGPS), derivatives thereof (e.g., doped versions thereof), or a combination thereof. In some examples, the interfacial material comprises Li₆PS₅Cl (LPSCl), Li₇P₃S₁₁ (LPS), garnet Li₇La₃Zr₂O₁₂ (LLZO), Li₃N, Li₃PS₄, Li₃P, or a combination thereof. In some examples, the interfacial material comprises Li₆PS₅Cl (LPSCl), Li₇P₃S₁₁ (LPS), garnet Li₇La₃Zr₂O₁₂ (LLZO), Li₃PS₄, or a combination thereof. In some examples, the interfacial material comprises Li₆PS₅Cl (LPSCl).

In some examples, the interfacial layer has an ionic conductivity of lithium of 1×10⁻⁸ Scm⁻¹ or more (e.g., 5×10⁻⁸ Scm⁻¹ or more, 1×10⁻⁷ Scm⁻¹ or more, 5×10⁻⁷ SCm⁻¹ or more, 1×10⁻⁶ SCm⁻¹ or more, 5×10⁻⁶ SCm⁻¹ or more, 1×10⁻⁵ Scm⁻¹ or more, 5×10⁻⁵ SCm⁻¹ or more, 1×10⁻⁴ Scm⁻¹ or more, 5×10⁻⁴ Scm⁻¹ or more, 1×10⁻³ Scm⁻¹ or more, 5×10⁻³ Scm⁻¹ or more, 1×10⁻² SCm⁻¹ or more, or 5×10⁻² SCm⁻¹ or more). In some examples, the interfacial layer has an ionic conductivity of lithium of 0.1 Scm⁻¹ or less (e.g., 5×10⁻² SCm⁻¹ or less, 1×10⁻² SCm⁻¹ or less, 5×10⁻³ Scm⁻¹ or less, 1×10⁻³ Scm⁻¹ or less, 5×10⁻⁴ SCm⁻¹ or less, 1×10⁻⁴ Scm⁻¹ or less, 5×10⁻⁵ Scm⁻¹ or less, 1×10⁻⁵ Scm⁻¹ or less, 5×10⁻⁶ SCm⁻¹ or less, 1×10⁻⁶ SCm⁻¹ or less, 5×10⁻⁷ Scm⁻¹ or less, 1×10⁻⁷ Scm⁻¹ or less, or 5×10⁻⁸ Scm⁻¹ or less). The ionic conductivity of lithium of the interfacial layer can range from any of the minimum values described above to any of the maximum values described above. For example, the interfacial layer can have an ionic conductivity of lithium of from 1×10⁻⁸ Scm⁻¹ to 0.1 Scm⁻¹ (e.g., from 1×10⁻⁸ to 5×10⁻⁴ Scm⁻¹, from 5×10⁻⁴ to 0.1 Scm⁻¹, from 1×10⁻⁸ to 5×10⁻⁷ Scm⁻¹, from 5×10⁻⁷ to 1×10⁻⁵ Scm⁻¹, from 1×10⁻⁵ to 5×10⁻³ Scm⁻¹, from 5×10⁻³ to 0.1 Scm⁻¹, 1×10⁻⁵ to 0.1 Scm⁻¹, from 1×10⁻⁶ to 0.1 Scm⁻¹, from 1×10⁻¹ to 0.1 Scm⁻¹, from 1×10⁻⁴ to 0.1 Scm⁻¹, from 1×10⁻³ to 0.1 Scm⁻¹, or from 1×10⁻² to 0.1 Scm⁻¹). The ionic conductivity of the interfacial layer can be measured using methods known in the art, such as using Electrochemical Impedance Spectroscopy (EIS) and then calculated with an ionic conductivity equation.

In some examples, the interfacial layer has an average thickness of 1 nanometer (nm) or more (e.g., 5 nm or more, 10 nm or more, 15 nm or more, 20 nm or more, 25 nm or more, 30 nm or more, 35 nm or more, 40 nm or more, 45 nm or more, 50 nm or more, 60 nm or more, 70 nm or more, 80 nm or more, 90 nm or more, 100 nm or more, 125 nm or more, 150 nm or more, 175 nm or more, 200 nm or more, 225 nm or more, 250 nm or more, 300 nm or more, 350 nm or more, 400 nm or more, 450 nm or more, 500 nm or more, 600 nm or more, 700 nm or more, 800 nm or more, 900 nm or more, 1 micrometer (micron, m) or more, 1.25 μm or more, 1.5 μm or more, 1.75 μm or more, 2 μm or more, 2.25 μm or more, 2.5 μm or more, 3 μm or more, 3.5 m or more, 4 μm or more, 4.5 μm or more, 5 μm or more, 6 μm or more, 7 μm or more, 8 μm or more, 9 μm or more, 10 μm or more, 15 μm or more, 20 μm or more, 25 μm or more, 30 μm or more, 35 μm or more, 40 μm or more, 45 μm or more, 50 μm or more, 60 μm or more, 70 μm or more, 80 μm or more, or 90 μm or more). In some examples, the interfacial layer can have an average thickness of 100 micrometers (microns, μm) or less (e.g., 90 μm or less, 80 μm or less, 70 μm or less, 60 μm or less, 50 μm or less, 45 μm or less, 40 μm or less, 35 μm or less, 30 m or less, 25 μm or less, 20 μm or less, 15 μm or less, 10 μm or less, 9 μm or less, 8 μm or less, 7 m or less, 6 μm or less, 5 μm or less, 4.5 μm or less, 4 μm or less, 3.5 μm or less, 3 μm or less, 2.5 μm or less, 2.25 μm or less, 2 μm or less, 1.75 μm or less, 1.5 μm or less, 1.25 μm or less, 1 m or less, 900 nanometers (nm) or less, 800 nm or less, 700 nm or less, 600 nm or less, 500 nm or less, 450 nm or less, 400 nm or less, 350 nm or less, 300 nm or less, 250 nm or less, 225 nm or less, 200 nm or less, 175 nm or less, 150 nm or less, 125 nm or less, 100 nm or less, 90 nm or less, 80 nm or less, 70 nm or less, 60 nm or less, 50 nm or less, 45 nm or less, 40 nm or less, 35 nm or less, 30 nm or less, 25 nm or less, 20 nm or less, 15 nm or less, 10 nm or less, or 5 nm or less). The average thickness of the interfacial layer can range from any of the minimum values described above to any of the maximum values described above. For example, the interfacial layer can have an average thickness of from 1 nanometer (nm) to 100 micrometers (microns, km) (e.g., from 1 nm to 1 μm, from 1 μm to 100 μm, from 1 nm to 10 nm, from 10 nm to 100 nm, from 100 nm to 1 μm, from 1 μm to 10 μm, from 10 μm to 100 μm, from 1 nm to 75 μm, from 1 nm to 50 μm, from 1 nm to 25 μm, from 1 nm to 10 μm, from 1 nm to 1 μm, from 1 nm to 100 nm, from 1 nm to 50 nm, from 1 nm to 25 nm, from 10 nm to 100 μm, from 25 nm to 100 m, from 50 nm to 100 μm, from 100 nm to 100 μm, from 1 μm to 100 μm, from 10 μm to 100 μm, from 25 μm to 100 μm, from 50 μm to 100 μm, from 5 nm to 95 μm, from 10 nm to 90 μm, from 25 nm to 75 μm, from 50 nm to 50 μm, from 75 nm to 25 μm, from 1 μm to 20 μm, or from 100 nm to 1 μm). In some examples, the interfacial layer can have an average thickness of from 100 nanometers (nm) to 20 micrometers (microns, μm). The thickness of the interfacial layer can be measured using methods known in the art, such as evaluation by electron microscopy (e.g., scanning electron microscopy, transmission electron microscopy, or a combination thereof) and/or dynamic light scattering. As used herein, the average thickness of the interfacial layer is determined by scanning electron microscopy.

In some examples, the interfacial layer can comprises a plurality of particles of the interfacial material.

The plurality of particles of the interfacial material can comprise particles of any shape desired for the specific application (e.g., a sphere, a rod, a quadrilateral, an ellipse, a triangle, a polygon, etc.). In some examples, the plurality of particles of the interfacial material can have an irregular shape, a regular shape, an isotropic shape, an anisotropic shape, or a combination thereof. In some examples, the plurality of particles of the interfacial material can have an isotropic shape. In some examples, the plurality of particles of the interfacial material are substantially spherical.

The plurality of particles of the interfacial material can have an average particle size. “Average particle size” and “mean particle size” are used interchangeably herein, and generally refer to the statistical mean particle size of the particles in a population of particles. For example, the average particle size for a plurality of particles with a substantially spherical shape can comprise the average diameter of the plurality of particles. For a particle with a substantially spherical shape, the diameter of a particle can refer, for example, to the hydrodynamic diameter. As used herein, the hydrodynamic diameter of a particle can refer to the largest linear distance between two points on the surface of the particle. For an anisotropic particle, the average particle size can refer to, for example, the average maximum dimension of the particle (e.g., the length of a rod shaped particle, the diagonal of a cube shape particle, the bisector of a triangular shaped particle, etc.). For an anisotropic particle, the average particle size can refer to, for example, the hydrodynamic size of the particle. Mean particle size can be measured using methods known in the art, such as evaluation by electron microscopy (e.g., scanning electron microscopy, transmission electron microscopy, or a combination thereof) and/or dynamic light scattering. As used herein, the average particle size is determined by scanning electron microscopy.

In some examples, the plurality of particles of the interfacial material can have an average particle size of 1 nanometer (nm) or more (e.g., 5 nm or more, 10 nm or more, 15 nm or more, 20 nm or more, 25 nm or more, 30 nm or more, 35 nm or more, 40 nm or more, 45 nm or more, 50 nm or more, 60 nm or more, 70 nm or more, 80 nm or more, 90 nm or more, 100 nm or more, 125 nm or more, 150 nm or more, 175 nm or more, 200 nm or more, 225 nm or more, 250 nm or more, 300 nm or more, 350 nm or more, 400 nm or more, 450 nm or more, 500 nm or more, 600 nm or more, 700 nm or more, 800 nm or more, 900 nm or more, 1 micrometer (micron, m) or more, 1.25 μm or more, 1.5 μm or more, 1.75 μm or more, 2 μm or more, 2.25 m or more, 2.5 μm or more, 3 μm or more, 3.5 μm or more, 4 μm or more, 4.5 μm or more, 5 m or more, 6 μm or more, 7 μm or more, 8 μm or more, 9 μm or more, 10 μm or more, 15 m or more, or 20 μm or more). In some examples, the plurality of particles of the interfacial material can have an average particle size of 25 micrometers (microns, μm) or less (e.g., 20 m or less, 15 μm or less, 10 μm or less, 9 μm or less, 8 μm or less, 7 μm or less, 6 μm or less, 5 m or less, 4.5 μm or less, 4 μm or less, 3.5 μm or less, 3 μm or less, 2.5 μm or less, 2.25 μm or less, 2 μm or less, 1.75 μm or less, 1.5 μm or less, 1.25 μm or less, 1 μm or less, 900 nanometers (nm) or less, 800 nm or less, 700 nm or less, 600 nm or less, 500 nm or less, 450 nm or less, 400 nm or less, 350 nm or less, 300 nm or less, 250 nm or less, 225 nm or less, 200 nm or less, 175 nm or less, 150 nm or less, 125 nm or less, 100 nm or less, 90 nm or less, 80 nm or less, 70 nm or less, 60 nm or less, 50 nm or less, 45 nm or less, 40 nm or less, 35 nm or less, 30 nm or less, 25 nm or less, 20 nm or less, 15 nm or less, 10 nm or less, or 5 nm or less). The average particle size of the plurality of particles of the interfacial material can range from any of the minimum values described above to any of the maximum values described above. For example, the plurality of particles of the interfacial material can have an average particle size of from 1 nanometers (nm) to 25 micrometers (microns, μm) (e.g., from 1 nm to 100 nm, from 100 nm to 25 μm, from 1 nm to 10 nm, from 10 nm to 100 nm, from 100 nm to 1 μm, from 1 μm to 10 μm, from 10 μm to 25 μm, from 1 nm to 20 μm, from 1 nm to 10 μm, from 1 nm to 1 μm, from 1 nm to 100 nm, from 1 nm to 50 nm, from 1 nm to 25 nm, from 10 nm to 25 μm, from 25 nm to 25 μm, from 50 nm to 25 μm, from 100 nm to 25 μm, from 1 μm to 25 μm, from 5 μm to 25 μm, from 10 μm to 25 μm, from 10 nm to 20 μm, from 50 nm to 15 μm, from 100 nm to 10 μm, or from 1 to 10 m). In some examples, the plurality of particles of the interfacial material can have an average particle size of from 100 nanometers (nm) to 10 micrometers (microns, μm).

In some examples, the plurality of particles of the interfacial material can be substantially monodisperse. “Monodisperse” and “homogeneous size distribution,” as used herein, and generally describe a population of particles where all of the particles are the same or nearly the same size. As used herein, a monodisperse distribution refers to particle distributions in which 80% of the distribution (e.g., 85% of the distribution, 90% of the distribution, or 95% of the distribution) lies within 25% of the average particle size (e.g., within 20% of the average particle size, within 15% of the average particle size, within 10% of the average particle size, or within 5% of the average particle size).

In some examples, the plurality of particles of the interfacial material can comprise: a first population of particles having a first average particle size, a first particle shape, and a first composition; and a second population of particles having a second average particle size, a second particle shape, and a second composition; wherein the first average particle size and the second average particle size are different, the first particle shape and the second particle shape are different, the first composition and the second composition are different, or a combination thereof. In some examples, the plurality of particles of the interfacial material can comprise a mixture of a plurality of populations of particles, wherein each population of particles within the mixture is different with respect to average particle size, shape, composition, or a combination thereof.

In some examples, the electrochemical stability window of the halide solid state electrolyte layer is compatible with the electrochemical stability window of the composite cathode. In some examples, the electrochemical stability window of the halide solid state electrolyte layer overlaps with the electrochemical stability window of the interfacial layer and the electrochemical stability window of the composite cathode.

### Halide Solid State Electrolyte Layer

The solid state batteries further comprise a halide solid state electrolyte layer, the halide solid state electrolyte layer being a layer comprising a first halide solid state electrolyte, wherein the first halide solid state electrolyte is any of the lithium ion conductors described herein (e.g., Formula I).

In some examples of the solid state batteries where there is no interfacial layer, the lithium ion conductor comprises Li₁₊ₓNb₁₋ₓZrₓOX₄, wherein X is a halide (e.g., F, Cl, Br, I, or a combination thereof) and x is from 0.2 to 0.7. In some examples of the solid state batteries where there is no interfacial layer, the lithium ion conductor comprises Li₁₊ₓNb₁₋ₓZrₓOX₄, wherein X is Cl and x is from 0.2 to 0.7.

In some examples of the solid state batteries including the interfacial layer, the lithium ion conductor comprises Li₁₊ₓNb₁₋ₓZrₓOX₄, wherein X is a halide (e.g., F, Cl, Br, I, or a combination thereof) and x is from 0.5 to 0.95. In some examples of the solid state batteries including the interfacial layer, the lithium ion conductor comprises Li₁₊ₓNb₁₋ₓZrₓOX₄, wherein X is Cl and x is from 0.5 to 0.95.

In some examples, the halide solid state electrolyte layer has an average thickness of 1 micrometer (micron, m) or more (e.g., 5 μm or more, 10 μm or more, 15 μm or more, 20 μm or more, 25 μm or more, 30 μm or more, 35 μm or more, 40 μm or more, 45 μm or more, 50 μm or more, 55 μm or more, 60 μm or more, 65 μm or more, 70 μm or more, 75 μm or more, 80 μm or more, 85 μm or more, 90 μm or more, or 95 μm or more). In some examples, the halide solid state electrolyte layer can have an average thickness of 100 micrometers (microns, μm) or less (e.g., 95 μm or less, 90 μm or less, 85 μm or less, 80 μm or less, 75 μm or less, 70 μm or less, 65 m or less, 60 μm or less, 55 μm or less, 50 μm or less, 45 μm or less, 40 μm or less, 35 μm or less, 30 μm or less, 25 μm or less, 20 μm or less, 15 μm or less, 10 μm or less, or 5 μm or less).

The average thickness of the halide solid state electrolyte layer can range from any of the minimum values described above to any of the maximum values described above. For example, the halide solid state electrolyte layer can have an average thickness of from 1 to 100 micrometers (microns, μm) (e.g., from 1 to 50 μm, from 50 to 100 μm, from 1 to 20 μm, from 20 to 40 μm, from 40 to 60 μm, from 60 to 80 μm, from 80 to 100 μm, from 1 to 80 μm, from 1 to 60 μm, from 1 to 40 μm, from 1 to 10 μm, from 5 to 100 μm, from 10 to 100 μm, from 20 to 100 am, from 40 to 100 μm, from 60 to 100 μm, from 5 to 95 μm, from 10 to 90 μm, or from 20 to 80 μm). The thickness of the halide solid state electrolyte layer can be measured using methods known in the art, such as evaluation by electron microscopy (e.g., scanning electron microscopy, transmission electron microscopy, or a combination thereof) and/or dynamic light scattering. As used herein, the average thickness of the halide solid state electrolyte layer is determined by scanning electron microscopy.

In some examples, the halide solid state electrolyte layer comprises a plurality of particles of the first halide solid state electrolyte.

The plurality of particles of the first halide solid state electrolyte can comprise particles of any shape desired for the specific application (e.g., a sphere, a rod, a quadrilateral, an ellipse, a triangle, a polygon, etc.). In some examples, the plurality of particles of the first halide solid state electrolyte can have an irregular shape, a regular shape, an isotropic shape, an anisotropic shape, or a combination thereof. In some examples, the plurality of particles of the first halide solid state electrolyte can have an isotropic shape. In some examples, the plurality of particles of the first halide solid state electrolyte are substantially spherical.

The plurality of particles of the first halide solid state electrolyte can have an average particle size. For example, the plurality of particles of the first halide solid state electrolyte can have an average particle size of 1 nanometer (nm) or more (e.g., 5 nm or more, 10 nm or more, 15 nm or more, 20 nm or more, 25 nm or more, 30 nm or more, 35 nm or more, 40 nm or more, 45 nm or more, 50 nm or more, 60 nm or more, 70 nm or more, 80 nm or more, 90 nm or more, 100 nm or more, 125 nm or more, 150 nm or more, 175 nm or more, 200 nm or more, 225 nm or more, 250 nm or more, 300 nm or more, 350 nm or more, 400 nm or more, 450 nm or more, 500 nm or more, 600 nm or more, 700 nm or more, 800 nm or more, 900 nm or more, 1 micrometer (micron, m) or more, 1.25 μm or more, 1.5 μm or more, 1.75 μm or more, 2 μm or more, 2.25 m or more, 2.5 μm or more, 3 μm or more, 3.5 μm or more, 4 μm or more, 4.5 μm or more, 5 m or more, 6 μm or more, 7 μm or more, 8 μm or more, 9 μm or more, 10 μm or more, 15 m or more, 20 μm or more, 25 μm or more, 30 μm or more, 35 μm or more, 40 μm or more, 45 m or more, 50 μm or more, 60 μm or more, 70 μm or more, 80 μm or more, or 90 μm or more). In some examples, the plurality of particles of the first halide solid state electrolyte can have an average particle size of 100 micrometers (microns, μm) or less (e.g., 90 μm or less, 80 μm or less, 70 μm or less, 60 μm or less, 50 μm or less, 45 μm or less, 40 μm or less, 35 μm or less, 30 m or less, 25 μm or less, 20 μm or less, 15 μm or less, 10 μm or less, 9 μm or less, 8 μm or less, 7 μm or less, 6 μm or less, 5 μm or less, 4.5 μm or less, 4 μm or less, 3.5 μm or less, 3 μm or less, 2.5 μm or less, 2.25 μm or less, 2 μm or less, 1.75 μm or less, 1.5 μm or less, 1.25 μm or less, 1 μm or less, 900 nanometers (nm) or less, 800 nm or less, 700 nm or less, 600 nm or less, 500 nm or less, 450 nm or less, 400 nm or less, 350 nm or less, 300 nm or less, 250 nm or less, 225 nm or less, 200 nm or less, 175 nm or less, 150 nm or less, 125 nm or less, 100 nm or less, 90 nm or less, 80 nm or less, 70 nm or less, 60 nm or less, 50 nm or less, 45 nm or less, 40 nm or less, 35 nm or less, 30 nm or less, 25 nm or less, 20 nm or less, 15 nm or less, 10 nm or less, or 5 nm or less). The average particle size of the plurality of particles of the first halide solid state electrolyte can range from any of the minimum values described above to any of the maximum values described above. For example, the plurality of particles of the first halide solid state electrolyte can have an average particle size of from 1 nanometers (nm) to 100 micrometers (microns, μm) (e.g., from 1 nm to 1 μm, from 1 μm to 100 μm, from 1 nm to 10 nm, from 10 nm to 100 nm, from 100 nm to 1 μm, from 1 μm to 10 μm, from 10 μm to 100 μm, from 1 nm to 75 μm, from 1 nm to 50 μm, from 1 nm to 25 μm, from 1 nm to 10 μm, from 1 nm to 1 μm, from 1 nm to 100 nm, from 1 nm to 50 nm, from 1 nm to 25 nm, from 10 nm to 100 μm, from 25 nm to 100 μm, from 50 nm to 100 μm, from 100 nm to 100 μm, from 1 μm to 100 μm, from 10 μm to 100 μm, from 25 μm to 100 μm, from 50 μm to 100 μm, from 5 nm to 95 μm, from 10 nm to 90 μm, from 25 nm to 75 μm, from 50 nm to 50 μm, from 75 nm to 25 μm, from 100 nm to 20 mam, or from 100 nm to 10 μm). In some examples, the plurality of particles of the first halide solid state electrolyte can have an average particle size of from 100 nanometers (nm) to 20 micrometers (microns, jm).

In some examples, the plurality of particles of the first halide solid state electrolyte can be substantially monodisperse.

In some examples, the plurality of particles of the first halide solid state electrolyte can comprise: a first population of particles having a first average particle size, a first particle shape, and a first composition; and a second population of particles having a second average particle size, a second particle shape, and a second composition; wherein the first average particle size and the second average particle size are different, the first particle shape and the second particle shape are different, the first composition and the second composition are different, or a combination thereof. In some examples, the plurality of particles of the first halide solid state electrolyte can comprise a mixture of a plurality of populations of particles, wherein each population of particles within the mixture is different with respect to average particle size, shape, composition, or a combination thereof.

In some examples, the electrochemical stability window of the halide solid state electrolyte layer is compatible with the electrochemical stability window of the composite cathode. In some examples, the electrochemical stability window of the halide solid state electrolyte layer overlaps with the electrochemical stability window of the interfacial layer and the electrochemical stability window of the composite cathode.

In some examples, the halide solid state electrolyte layer is high-voltage stable. For example, the halide solid state electrolyte layer can be stable at a voltage of −0.1 V or more vs.

Li⁺/Li⁰ (e.g., 0 V or more, 0.5 V or more, 1 V or more, 1.5 V or more, 2 V or more, 2.5 V or more, 3 V or more, 3.5 V or more, 4 V or more, 4.5 V or more, or 5 V or more). In some examples, the halide solid state electrolyte layer can be stable at a voltage of 5.5 V or less vs. Li⁺/Li⁰ (e.g., 5 V or less, 4.5 V or less, 4 V or less, 3.5 V or less, 3 V or less, 2.5 V or less, 2 V or less, 1.5 V or less, 1 V or less, 0.5 V or less, or 0 V or less). The voltage at which the halide solid state electrolyte layer is stable can range from any of the minimum values described above to any of the maximum values described above. For example, the halide solid state electrolyte layer can be stable at a voltage of from −0.1 V to 5.5 V vs. Li⁺/Li⁰ (e.g., from −0.1 to 2.5 V, from 2.5 to 5.5 V, from −0.1 to 5 V, from −0.1 to 4.5 V, from −0.1 to 4 V, from −0.1 to 3.5 V, from −0.1 to 3 V, from −0.1 to 2.5 V, from −0.1 to 2 V, from −0.1 to 1.5 V, from −0.1 to 1 V, from 0 to 5.5 V, from 0.5 to 5.5 V, from 1 to 5.5 V, from 1.5 to 5.5 V, from 2 to 5.5 V, from 2.5 to 5.5 V, from 3 to 5.5 V, from 3.5 to 5.5 V, from 4 to 5.5 V, from 0 to 5 V, or from 1 to 5 V). As used herein, “stable” means mean no reaction occur or a reaction occurs that is favorable for lithium-transport (e.g., Li-ion conducting reaction products).

### Composite Cathode

The solid state batteries further comprise a composite cathode. The composite cathode comprises a cathode active material, a conductive additive, and an electrolyte. The electrolyte of the composite cathode comprises: a plurality of particles comprising a second halide solid state electrolyte; or a liquid electrolyte, a polymer electrolyte, and/or a gel electrolyte.

### Cathode Active Material

The cathode active material can comprise any suitable material, such as those known in the art. Examples of suitable cathode active materials include, but are not limited to, high density nickel-rich layered transition metal oxides (e.g., Li[NiₓMn_{y}Co_{z}]O₂ (x+y+z=1)), LiFe₁₋ₓMnₓPO₄ (LMFP), lithium iron phosphate (LFP, LiFePO₄), lithium manganese oxide (LiMn₂O₄), nickel-doped lithium manganese oxide (Li[Ni_{0.5}Mn_{1.5}]O₄), LiCoO₂, LiNiO₂, and combinations thereof.

In some examples, the cathode active material comprises Li[NiₓMn_{y}Co_{z}]O₂ where x+y+z=1, LiFePO₄, or a combination thereof. In some examples, the cathode active material comprises Li[NiₓMn_{y}Co_{z}]O₂ where x+y+z=1. In some examples, the cathode active material comprises LiNi_{0.8}Mn_{0.1}Co_{0.1}O₂.

### Conductive Additive

The conductive additive can comprise any suitable material, such as those known in the art. Examples of suitable conductive additives include, but are not limited to, carbon black, modified carbon black, graphene, multi-layer graphene, carbon fibers, carbon nanotubes, carbon nanospheres, graphite, reduced graphene oxide, and combinations thereof. In some examples, the conductive additive comprises carbon black.

### Binder

In some examples, the composite cathode further comprises a binder. Examples of suitable binders are known in the art. For example, the binder can comprise a polyethylene oxide (PEO), polyvinylidene fluoride (PVDF), polytetrafluoroethylene (PTFE), cellulose, carboxymethylcellulose (CMC), styrene-butadiene rubber (SBR), polyacrylic acid (PAA), polyvinyl alcohol (PVA), polyvinyl butyral (PVB), polyvinylpyrrolidone (PVP), ethyl cellulose (EC), copolymers thereof, derivatives thereof, or a combination thereof.

### Cathode Electrolyte

In some examples, the solid state battery is a pseudo solid state battery. In some examples, the solid state battery is a pseudo solid state battery and the electrolyte of the composite cathode is a liquid electrolyte, a polymer electrolyte, and/or a gel electrolyte.

In some examples, the solid state battery is an all solid state battery. In some examples, the solid state battery is an all solid state battery and the electrolyte of the composite cathode is a plurality of particles comprising a second halide solid state electrolyte.

The second halide solid state electrolyte can comprise any suitable material, such as those known in the art. Examples of suitable materials for the second halide solid state electrolyte include, but are not limited to, lithium halides, sodium halides, or a combination thereof. In some examples, the second halide solid state electrolyte comprises a lithium halide.

In some examples, the second halide solid state electrolyte comprises any of the lithium ion conductors described herein (e.g., Formula I).

In some examples, the second halide solid state electrolyte comprises Li_{3-z}M[^{III+z}]X₆, where X is one or more halides (e.g., F, Cl, Br, I, or a combination thereof), z is an integer from −2 to 2 (e.g., z is −2, −1, 0, 1, or 2), and [III+z] represents the valence of the M-ion(s) in the compound. In some examples, M can be a metal, such as a transition metal, a post transition metal, or a combination thereof. In some examples, M can be Y, In, Zr, or a combination thereof.

In some examples, M can be Y and/or Zr. In some examples, the second halide solid state electrolyte can comprise Li₃YX₆, where X is F, Cl, Br, I, or a combination thereof. In some examples, the second halide solid state electrolyte can comprise Li₂ZrX₆, where X is F, Cl, Br, I, or a combination thereof. In some examples, the second halide solid state electrolyte comprises Li₃YCl₆, Li₂ZrCl₆, or a combination thereof.

The second halide solid state electrolyte and the first halide solid state electrolyte can be the same or different.

In some examples, the second halide solid state electrolyte can have an ionic conductivity of lithium of 1×10⁻⁶ SCm⁻¹ or more (e.g., 5×10⁻⁶ SCm⁻¹ or more, 1×10⁻⁵ Scm⁻¹ or more, 5×10⁻⁵ Scm⁻¹ or more, 1×10⁻⁴ Scm⁻¹ or more, 5×10⁻⁴ Scm⁻¹ or more, 1×10⁻³ Scm⁻¹ or more, 5×10⁻³ Scm⁻¹ or more, 1×10⁻² SCm⁻¹ or more, 5×10⁻² SCm⁻¹ or more, 0.1 Scm⁻¹ or more, or 0.5 Scm⁻¹ or more). In some examples, the second halide solid state electrolyte can have an ionic conductivity of lithium of 1 Scm⁻¹ or less (e.g., 0.5 Scm⁻¹ or less, 0.1 Scm⁻¹ or less, 5×10⁻² SCm 1 or less, 1×10⁻² SCm⁻¹ or less, 5×10⁻³ Scm⁻¹ or less, 1×10⁻³ Scm⁻¹ or less, 5×10⁻⁴ Scm⁻¹ or less, 1×10⁻⁴ SCm⁻¹ or less, 5×10⁻⁵ Scm⁻¹ or less, 1×10⁻⁵ Scm⁻¹ or less, or 5×10⁻⁶ SCm⁻¹ or less). The ionic conductivity of lithium of the second halide solid state electrolyte can range from any of the minimum values described above to any of the maximum values described above. For example, the second halide solid state electrolyte can have an ionic conductivity of lithium of from 1×10⁻⁶ SCm⁻¹ to 1 Scm⁻¹ (e.g., from 1×10⁻⁶ to 1×10⁻³ Scm⁻¹, from 1×10⁻³ to 1 Scm⁻¹, from 1×10⁻⁶ to 1×10⁻⁵ Scm⁻¹, from 1×10⁻⁵ to 1×10⁻⁴ Scm⁻¹, from 1×10⁻⁴ to 1×10-Scm⁻¹, from 1×10⁻³ to 1×10⁻² Scm⁻¹, from 1×10⁻² to 0.1 Scm⁻¹, from 0.1 to 1 Scm⁻¹, from 1×10⁻⁵ to 1 Scm⁻¹, from 1×10⁻⁴ to 1 Scm⁻¹, or from 1×10⁻² to 1 Scm⁻¹). The ionic conductivity can be measured using methods known in the art, such as using Electrochemical Impedance Spectroscopy (EIS) and then calculated with an ionic conductivity equation.

The plurality of particles of the second halide solid state electrolyte can comprise particles of any shape desired for the specific application (e.g., a sphere, a rod, a quadrilateral, an ellipse, a triangle, a polygon, etc.). In some examples, the plurality of particles of the second halide solid state electrolyte can have an irregular shape, a regular shape, an isotropic shape, an anisotropic shape, or a combination thereof. In some examples, the plurality of particles of the second halide solid state electrolyte can have an isotropic shape. In some examples, the plurality of particles of the second halide solid state electrolyte are substantially spherical. In some examples, the shape of the plurality of particles of the first halide solid state electrolyte and the shape of the plurality of particles of the second halide solid state electrolyte can be the same or different.

The plurality of particles of the second halide solid state electrolyte can have an average particle size. For example, the plurality of particles of the second halide solid state electrolyte can have an average particle size of 1 nanometer (nm) or more (e.g., 5 nm or more, 10 nm or more, 15 nm or more, 20 nm or more, 25 nm or more, 30 nm or more, 35 nm or more, 40 nm or more, 45 nm or more, 50 nm or more, 60 nm or more, 70 nm or more, 80 nm or more, 90 nm or more, 100 nm or more, 125 nm or more, 150 nm or more, 175 nm or more, 200 nm or more, 225 nm or more, 250 nm or more, 300 nm or more, 350 nm or more, 400 nm or more, 450 nm or more, 500 nm or more, 600 nm or more, 700 nm or more, 800 nm or more, 900 nm or more, 1 micrometer (micron, m) or more, 1.25 μm or more, 1.5 μm or more, 1.75 μm or more, 2 μm or more, 2.25 μm or more, 2.5 μm or more, 3 μm or more, 3.5 μm or more, 4 μm or more, 4.5 m or more, 5 μm or more, 6 μm or more, 7 μm or more, 8 μm or more, 9 μm or more, 10 μm or more, 15 μm or more, 20 μm or more, 25 μm or more, 30 μm or more, 35 μm or more, 40 μm or more, or 45 μm or more). In some examples, the plurality of particles of the second halide solid state electrolyte can have an average particle size of 50 micrometers (microns, μm) or less (e.g., m or less, 40 μm or less, 35 μm or less, 30 μm or less, or 25 μm or less, 20 μm or less, 15 m or less, 10 μm or less, 9 μm or less, 8 μm or less, 7 μm or less, 6 μm or less, 5 μm or less, 4.5 m or less, 4 μm or less, 3.5 μm or less, 3 μm or less, 2.5 μm or less, 2.25 μm or less, 2 μm or less, 1.75 μm or less, 1.5 μm or less, 1.25 μm or less, 1 μm or less, 900 nanometers (nm) or less, 800 nm or less, 700 nm or less, 600 nm or less, 500 nm or less, 450 nm or less, 400 nm or less, 350 nm or less, 300 nm or less, 250 nm or less, 225 nm or less, 200 nm or less, 175 nm or less, 150 nm or less, 125 nm or less, 100 nm or less, 90 nm or less, 80 nm or less, 70 nm or less, 60 nm or less, 50 nm or less, 45 nm or less, 40 nm or less, 35 nm or less, 30 nm or less, 25 nm or less, 20 nm or less, 15 nm or less, 10 nm or less, or 5 nm or less). The average particle size of the plurality of particles of the second halide solid state electrolyte can range from any of the minimum values described above to any of the maximum values described above. For example, the plurality of particles of the second halide solid state electrolyte can have an average particle size of from 1 nanometers (nm) to 50 micrometers (microns, μm) (e.g., from 1 nm to 1 μm, from 1 μm to 50 μm, from 1 nm to 10 nm, from 10 nm to 100 nm, from 100 nm to 1 μm, from 1 μm to 10 μm, from 10 μm to 50 μm, from 1 nm to 25 μm, from 1 nm to 10 μm, from 1 nm to 5 μm, from 1 nm to 750 nm, from 1 nm to 500 nm, from 1 nm to 250 nm, from 1 nm to 100 nm, from 1 nm to 50 nm, from 1 nm to 25 nm, from 5 nm to 50 μm, from 10 nm to 50 μm, from 25 nm to 50 am, from 50 nm to 50 μm, from 100 nm to 50 μm, from 250 nm to 50 μm, from 500 nm to 50 am, from 750 nm to 50 μm, from 5 μm to 50 μm, from 10 μm to 50 μm, from 25 μm to 50 μm, from 5 nm to 45 μm, from 10 nm to 40 μm, from 50 nm to 30 μm, or from 100 nm to 20 m). In some examples, the plurality of particles of the second halide solid state electrolyte can have an average particle size of from 100 nanometers to 20 micrometers. In some examples, the average particle size of the plurality of particles of the first halide solid state electrolyte and the average particle size of the plurality of particles of the second halide solid state electrolyte can be the same or different.

In some examples, the plurality of particles of the second halide solid state electrolyte can be substantially monodisperse.

In some examples, the plurality of particles of the second halide solid state electrolyte can comprise: a first population of particles having a first average particle size, a first particle shape, and a first composition; and a second population of particles having a second average particle size, a second particle shape, and a second composition; wherein the first average particle size and the second average particle size are different, the first particle shape and the second particle shape are different, the first composition and the second composition are different, or a combination thereof. In some examples, the plurality of particles of the second halide solid state electrolyte can comprise a mixture of a plurality of populations of particles, wherein each population of particles within the mixture is different with respect to average particle size, shape, composition, or a combination thereof.

In some examples, the plurality of particles of the first halide solid state electrolyte can comprise a first population of particles having a first average particle size, a first particle shape, and a first composition; and the plurality of particles of the second halide solid state electrolyte can comprise a second population of particles having a second average particle size, a second particle shape, and a second composition; wherein the first average particle size and the second average particle size can be the same or different, the first particle shape and the second particle shape can be the same or different, the first composition and the second composition can be the same or different, or a combination thereof.

### Current Collector(s)

In some examples, the solid state battery further comprises a first current collector. When the anode is present, the anode is sandwiched between and in contact with the first current collector and the interfacial layer (when present) or the halide solid state electrolyte layer (when the interfacial layer is absent). When the anode is absent, the current collector is in contact with the interfacial layer (when present) or the halide solid state electrolyte layer (when the interfacial layer is absent).

In some examples, the solid state battery further comprises a second current collector, wherein the cathode is sandwiched between and in contact with the second current collector and the halide solid state electrolyte layer.

The first current collector and/or the second current collector (when present) can independently comprise any suitable material, such as those known in the art. For example, The first current collector and/or the second current collector (when present) can independently comprise a metal, a carbon material, or a combination thereof.

In some examples, the first current collector and/or the second current collector (when present) can independently comprise a metal foil and/or a metal foam. In some examples, the first current collector and/or the second current collector (when present) can independently comprise copper, nickel, aluminum, or a combination thereof. Examples of suitable carbon-based conductive materials include, but are not limited to graphitic carbon and graphites, including amorphous carbon, carbon black, graphene, and others known in the art.

### Casing

In some examples, the solid state battery can further include a casing that at least partially surrounds and/or encloses a cell comprising the anode (when present), the interfacial layer (when present), the halide solid state electrolyte layer, the composite cathode, the first current collector (when present), and the second current collector (when present).

The casing can comprise any suitable material such as those known in the art. For example, the casing can comprise a polymer, a metal, an alloy, a polymer coated metal foil, or a combination thereof.

### Solid State Battery Properties

In some examples, the anode is substantially free of dendrites during a plating/stripping cycle of operation of the solid state battery.

In some examples, the interfacial layer (when present) is substantially free of dendrites during a plating/stripping cycle of operation of the solid state battery.

In some examples, the solid state battery exhibits an energy density of 75 Wh/kg or more (e.g., 100 Wh/kg or more, 125 Wh/kg or more, 150 Wh/kg or more, 175 Wh/kg or more, 200 Wh/kg or more, 225 Wh/kg or more, 250 Wh/kg or more, 275 Wh/kg or more, 300 Wh/kg or more, 325 Wh/kg or more, 350 Wh/kg or more, 375 Wh/kg or more, 400 Wh/kg or more, 425 Wh/kg or more, 450 Wh/kg or more, 475 Wh/kg or more, 500 Wh/kg or more, 525 Wh/kg or more, 550 Wh/kg or more, or 575 Wh/kg or more). In some examples, the solid state battery exhibits an energy density of 600 Wh/kg or less (e.g., 575 Wh/kg or less, 550 Wh/kg or less, 525 Wh/kg or less, 500 Wh/kg or less, 475 Wh/kg or less, 450 Wh/kg or less, 425 Wh/kg or less, 400 Wh/kg or less, 375 Wh/kg or less, 350 Wh/kg or less, 325 Wh/kg or less, 300 Wh/kg or less, 275 Wh/kg or less, 250 Wh/kg or less, 225 Wh/kg or less, 200 Wh/kg or less, 175 Wh/kg or less, 150 Wh/kg or less, 125 Wh/kg or less, or 100 Wh/kg or less). The energy density of the solid state battery can range from any of the minimum values described above to any of the maximum values described above. For example, the solid state battery can exhibit an energy density of from 75 Wh/kg to 600 Wh/kg (e.g., from 75 to 325 Wh/kg, from 325 to 600 Wh/kg, from 75 to 200 Wh/kg, from 200 to 325 Wh/kg, from 325 to 450 Wh/kg, from 450 to 600 Wh/kg, from 100 to 600 Wh/kg, from 200 to 600 Wh/kg, from 300 to 600 Wh/kg, from 400 to 600 Wh/kg, or from 500 to 600 Wh/kg). The energy density of the solid state battery can be measured and/or calculated using methods known in the art. For example, the energy density of the battery can be determined from the energy the solid state battery can hold and the total weight of the solid state battery.

In some examples, the solid state battery exhibits a specific discharge capacity of 100 mA h/g or more when discharged at a rate of from 0.1 C to 10 C (e.g., 125 mA h/g or more, 150 mA h/g or more, 175 mA h/g or more, 200 mA h/g or more, 225 mA h/g or more, 250 mA h/g or more, 275 mA h/g or more, 300 mA h/g or more, 325 mA h/g or more, 350 mA h/g or more, or 375 mA h/g or more). In some examples, the solid state battery exhibits a specific discharge capacity of 400 mA h/g or less when discharged at a rate of from 0.1 C to 10 C (e.g., 375 mA h/g or less, 350 mA h/g or less, 325 mA h/g or less, 300 mA h/g or less, 275 mA h/g or less, 250 mA h/g or less, 225 mA h/g or less, 200 mA h/g or less, 175 mA h/g or less, 150 mA h/g or less, or 125 mA h/g or less). The specific discharge capacity of the solid state battery can range from any of the minimum values described above to any of the maximum values described above. For example, the solid state battery can exhibit a specific discharge capacity of from 100 mA h/g to 400 mA h/g when discharged at a rate of from 0.1 C to 10 C (e.g., from 100 to 250 mA h/g, from 250 to 400 mA h/g, from 100 to 200 mA h/g, from 200 to 300 mA h/g, from 300 to 400 mA h/g, from 150 to 400 mA h/g, from 200 to 400 mA h/g, from 250 to 400 mA h/g, or from 350 to 400 mA h/g). The specific discharge capacity of the solid state battery can be calculated and/or theoretical. The specific discharge capacity of the solid state battery can be measured and/or calculated using methods known in the art. For example, the specific discharge capacity of the solid state battery can be measured using Galvanostatic cycling.

In some examples, the solid state battery is rechargeable.

In some examples, the solid state battery exhibits a coulombic efficiency of 80% or more (e.g., 85% or more, 90% or more, or 95% or more) for 100 cycles or more. In some examples, the solid state battery exhibits a coulombic efficiency of 99% or more for 100 cycles or more (e.g., 99.1% or more, 99.2% or more, 99.3% or more, 99.4% or more, 99.5% or more, 99.6% or more, 99.7% or more, 99.8% or more, or 99.9% or more). The coulombic efficiency of the solid state battery over 100 cycles or more can be calculated and/or measured using methods known in the art. For example, the coulombic efficiency of the solid state battery can be measured by comparing the capacity of the solid state battery at any given cycle against the first cycle. The cycle life of a battery is said to be when the measured capacity of the cell reaches 80% of its original value.

In some examples, the solid state battery exhibits a capacity retention of 80% or more (e.g., 85% or more, 90% or more, or 95% or more) for 100 cycles or more. In some examples, the solid state battery exhibits a capacity retention of 90% or more for 100 cycles or more (e.g., 91% or more, 92% or more, 93% or more, 94% or more, 95% or more, 96% or more, 97% or more, 98% or more, or 99% or more). The capacity retention of the solid state battery over 100 cycles or more can be calculated and/or measured using methods known in the art. For example, the capacity retention of the solid state battery can be measured by comparing the capacity of the solid state battery at any given cycle against the first cycle.

### Methods of Making and Use of Solid State Batteries

Also disclosed herein are methods of making and use of any of the solid state batteries disclosed herein.

For example, also disclosed herein are methods of making any of the solid state batteries disclosed herein. The methods can, for example, comprise a dry chemical process in which the cathode and anode (when present) are produced separately and the halide solid state electrolyte material and the interfacial layer (when present) are produced as freestanding films or membranes and the entire cell is sandwiched together.

Also disclosed herein are methods of use of any of the solid state batteries disclosed herein, for example in a system and/or an article.

Also disclosed herein are systems comprising one or more of the solid state batteries disclosed herein. For example, the system can be an energy storage system.

Also disclosed herein are articles (e.g., articles of manufacture) comprising one or more of the solid state batteries disclosed herein. For example, the article can be a vehicle, such as a hybrid electric vehicle or an all-electric vehicle. In some examples, the article can comprise an electronic device, such as a portable electronic device, a laptop, a watch, a cell phone, etc.

A number of embodiments of the invention have been described. Nevertheless, it will be understood that various modifications may be made without departing from the spirit and scope of the invention. Accordingly, other embodiments are within the scope of the following claims.

The examples below are intended to further illustrate certain aspects of the systems and methods described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of measurement conditions, e.g., component concentrations, temperatures, pressures and other measurement ranges and conditions that can be used to optimize the described process.

### Example 1

A series of oxyhalide solid electrolyte materials of the composition Li₁₊ₓNb₁₋ₓZrₓOCl₄ (LNZOC; x=0, 0.1, 0.3, 0.5, 0.7, 0.9, and 1.0) have been synthesized with a two-step ball-milling method without any calcination step. The materials were evaluated for their critical properties that are indicative of their applicability towards all-solid-state lithium batteries. All-solid-state coin cells were assembled as proof of the ability for these materials to serve as a viable solid electrolyte for all-solid-state batteries.

Detailed description Ceramic oxyhalide electrolyte materials have been developed for all-solid-state lithium metal batteries (LMBs), which comprise Niobium(V) and Zirconium(IV). By adjusting the molar ratio of reagents Niobium(V) chloride (NbCl₅) and Zirconium(IV) chloride (ZrCl₄), the oxyhalide structure Li₁₊ₓNb₁₋ₓZrₓOCl₄ (LNZOC; x=0, 0.1, 0.3, 0.5, 0.7, 0.9, and 1.0) can be synthesized with corresponding amount of reagent Lithium hydroxide (LiOH). All the appropriate amounts of reagents were ball-milled with a planetary ball-milling machine at 450 rpm for 12 hrs, followed by a high-energy ball-milling machine for another 6 hrs. Then no further processing is required to obtain the final LNZOC products.

LiNbOCl₄ (LNOC) oxyhalide electrolyte material has been shown to be able to deliver an ionic conductivity as high as 10 mS/cm. However, the stability of LNOC electrolyte against lithium metal is not acceptable for practical applications of all-solid-state lithium metal batteries (LMBs). Therefore, Zr(IV) was introduced to partially replace Nb(V) in the LNOC structure and bringing the corresponding amount of Li(I) to balance the charge in the LNZOC structure. Thereby, the stability of LNZOC with lithium metal can be enhanced by the more stable Zr element and more Li(I) component.

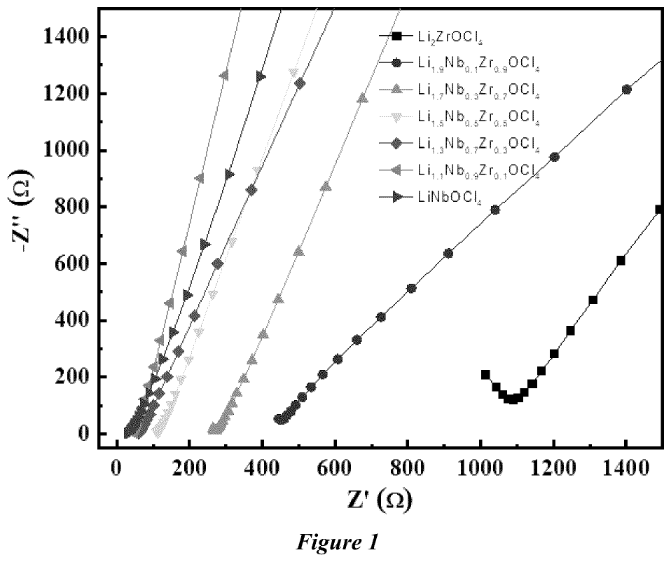

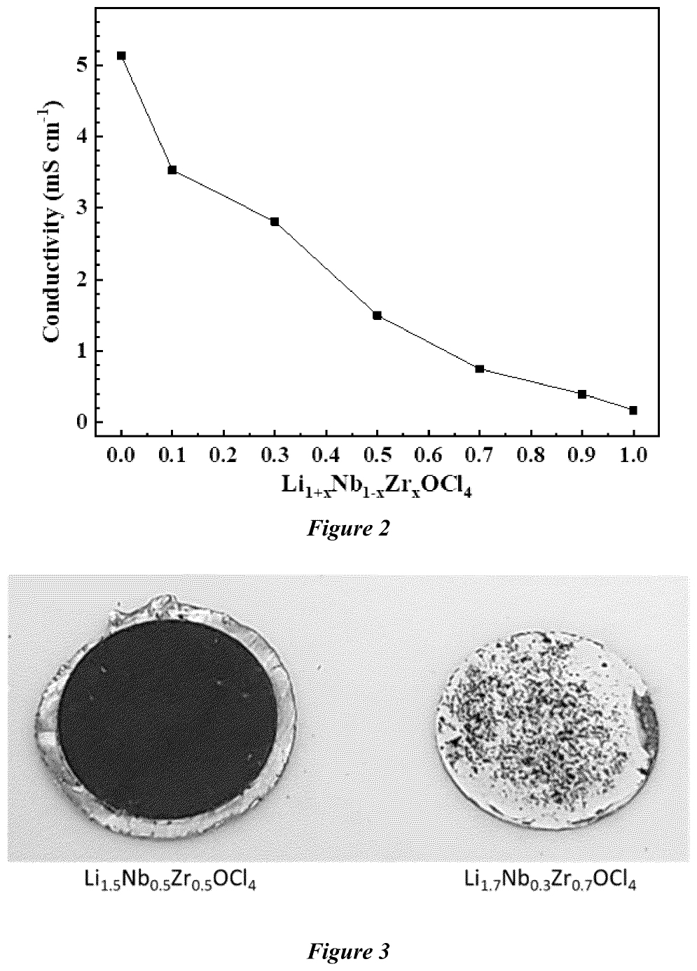

The electrochemical impedance spectra results and ionic conductivity data for the oxyhalide electrolyte materials were evaluated by pressing the LNZOC powder samples into pellets of Φ10 mm and 1 mm thickness, as shown in FIG. 1 and FIG. 2. Alternating current (AC) impedance measurements were carried out using a split cell, and recorded as EIS data on a Bio-Logic VSP instrument over a frequency range of 1 MHz to 1 Hz with a perturbation amplitude of 10 mv. The ionic conductivities (a) of the oxyhalide electrolytes were calculated according to the following equation:

$$σ = \frac{L}{R \times S}$$

where R is the bulk electrolyte resistance, and L and S are the thickness and area of the pressed electrolyte pellet, respectively. The ionic conductivities of LNZOC materials are summarized in Table 1.

TABLE 1
Summary of Ionic conductivities calculated for the Li1 +
xNb1 − xZrxOCl4 series of materials.

| Material Composition | Calculated Ionic Conductivity (mS/cm) |
|---|---|
| LiNbOCl₄ | 5.13 |
| Li_{1.1}Nb_{0.9}Zr_{0.1}OCl₄ | 3.53 |
| Li_{1.3}Nb_{0.7}Zr_{0.3}OCl₄ | 2.81 |
| Li_{1.5}Nb_{0.5}Zr_{0.5}OCl₄ | 1.50 |
| Li_{1.7}Nb_{0.3}Zr_{0.7}OCl₄ | 0.75 |
| Li_{1.9}Nb_{0.1}Zr_{0.9}OCl₄ | 0.40 |
| Li₂ZrOCl₄ | 0.17 |

On the other hand, the lithium metal contact stability of LNZOC materials was improved with the increased Zr proportion. To confirm, contact tests with pure lithium metal foil were carried out for each LNZOC material, in which the LNZOC powder samples were pressed into a pellet of ΦD10 mm and 1 mm thickness. After contacting for 12 hrs, the LNZOC pellets with over 0.7 proportion of Zr element (Li_{1.7}Nb_{0.3}Zr_{0.7}OCl₄, Li_{1.9}Nb_{0.1}Zr_{0.9}OCl₄, and Li₂ZrOCl₄) mostly kept their original white color, while the other pellets all turned totally dark. FIG. 3 shows a photo of two examples of lithium metal contact test results.

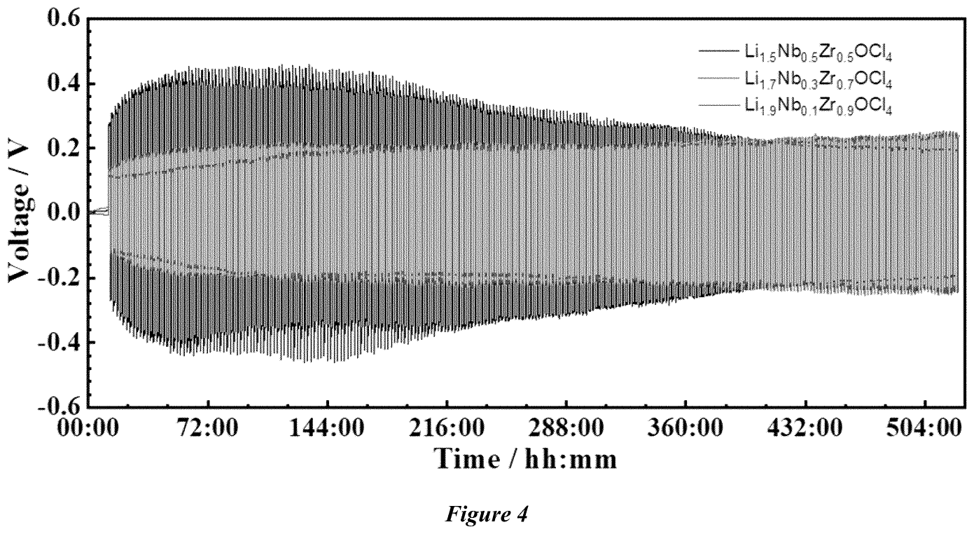

The same conclusion can also be summarized from the cycling performance of the Li/Li symmetric coin cells. As shown in FIG. 4, the initial over-potential of the Li/Li symmetric coin cells are ˜0.15 V, ˜0.2 V, and ˜0.4 V for Li_{1.9}Nb_{0.1}Zr_{0.9}OCl₄, Li_{1.7}Nb_{0.3}Zr_{0.7}OCl₄, and Li_{1.5}Nb_{0.5}Zr_{0.5}OCl₄, respectively. The increasing over-potential indicates that the chemical stability of LNZOC materials with lithium metal decreases with the decreased Zr proportion.

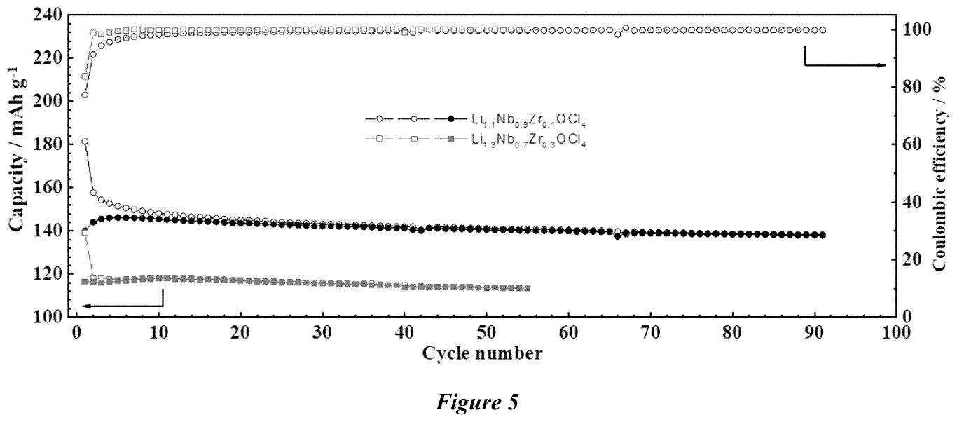

To evaluate the practical application potential of the LNZOC oxyhalide electrolyte materials, all-solid-state coin cells were built for long cycling stability tests. NMC811 was used as cathode active material in those cells, while Li₆PS₅Cl (LPSCl) served as an interfacial layer in between of LNZOC electrolyte and Li/In alloy anode. The coin cells were made by the layer-by-layer dry pressing method. FIG. 5 shows the cycling performance data of the coin cells based on selected LNZOC electrolyte materials (Li_{1.1}Nb_{0.9}Zr_{0.1}OCl₄ and Li_{1.3}Nb_{0.7}Zr_{0.3}OCl₄) at the current rate of C/10 under room temperature and without external pressure. With increasing Zr proportion (e.g., decreasing conductivities), the obtained specific capacities also decreased continuously from Li_{1.1}Nb_{0.9}Zr_{0.1}OCl₄ to Li_{1.9}Nb_{0.1}Zr_{0.9}OCl₄. In contrast, the Coulombic efficiencies and cycling stability are all improved by the increased Zr proportion, as well as the Li amount in the LNZOC oxyhalide electrolyte materials.

### Example 2

Described herein is a series of oxyhalide solid electrolyte materials of the composition Li₁₊ₓNb₁₋ₓZrₓOX₄ (LNZOC) where 0≤x≤1 and X is a halide. Methods of making and use of the materials are also disclosed, such as their applicability towards all-solid-state lithium batteries.

In some examples, the compositions can comprise Li₁₊ₓNb₁₋ₓZrₓOX₄ where 0.05≤x≤0.95.

In some examples, the compositions can comprise Li₁₊ₓNb₁₋ₓZrₓOCl₄ (LNZOC) where 0.05≤x≤0.95.

In a battery where the oxyhalide solid electrolyte material is the only electrolyte, the composition can comprise Li₁₊ₓNb₁₋ₓZrₓOX₄ (LNZOC) where 0.2≤x≤0.7 and X is a halide.

In a battery where the oxyhalide solid electrolyte material comprises a catholyte and the battery further comprises an interfacial layer, the composition can comprise Li₁₊ₓNb₁₋ₓZrₓOX₄ (LNZOC) where 0.5≤x≤0.95 and X is a halide.

### Exemplary Aspects

In view of the described lithium ion conductors and batteries (such as pseudo solid-state and all solid-state batteries) and methods of making and use thereof, herein below are described certain more particularly described aspects of the inventions. The particularly recited aspects should not, however, be interpreted to have any limiting effect on any different claims containing different or more general teachings described herein or that the “particular” aspects are somehow limited in some way other than the inherent meanings of the language and formulas literally used therein.

Example 1: A lithium ion conductor comprising a compound of Formula I:

Li₁₊ₓNb₁₋ₓZrₓOX₄ I

wherein X is a halide (e.g., F, Cl, Br, I, or a combination thereof); and x is from greater than 0 to less than 1 (e.g., 0≤x≤1).

Example 2: The lithium ion conductor of any examples herein, particularly example 1, wherein x is from 0.05 to 0.95.

Example 3: The lithium ion conductor of any examples herein, particularly example 1 or example 2, wherein x is from 0.2 to 0.95.

Example 4: The lithium ion conductor of any examples herein, particularly examples 1-3, wherein x is from 0.2 to 0.7.

Example 5: The lithium ion conductor of any examples herein, particularly examples 1-3, wherein x is from 0.5 to 0.95.

Example 6: The lithium ion conductor of any examples herein, particularly examples 1-5, wherein X is Cl.

Example 7: The lithium ion conductor of any examples herein, particularly examples 1-6, wherein X is Cl and x is from 0.05 to 0.95.

Example 8: The lithium ion conductor of any examples herein, particularly examples 1-7, wherein X is Cl and x is from 0.2 to 0.95.

Example 9: The lithium ion conductor of any examples herein, particularly examples 1-8, wherein X is Cl and x is from 0.2 to 0.7.

Example 10: The lithium ion conductor of any examples herein, particularly examples 1-8, wherein X is Cl and x is from 0.5 to 0.95.

Example 11: The lithium ion conductor of any examples herein, particularly examples 1-10, wherein the lithium ion conductor comprises Li_{1.1}Nb_{0.9}Zr_{0.1}OCl₄, Li_{1.3}Nb_{0.7}Zr_{0.3}OCl₄, Li_{1.5}Nb_{0.5}Zr_{0.5}OCl₄, Li_{1.7}Nb_{0.3}Zr_{0.7}OCl₄, Li_{1.9}Nb_{0.1}Zr_{0.9}OCl₄, or a combination thereof.

Example 12: The lithium ion conductor of any examples herein, particularly examples 1-11, wherein the lithium ion conductor comprises Li_{1.3}Nb_{0.7}Zr_{0.3}OCl₄, Li_{1.5}Nb_{0.5}Zr_{0.5}OCl₄, Li_{1.7}Nb_{0.3}Zr_{0.7}OCl₄, Li_{1.9}Nb_{0.1}Zr_{0.9}OCl₄, or a combination thereof.

Example 13: The lithium ion conductor of any examples herein, particularly examples 1-12, wherein the lithium ion conductor comprises Li_{1.3}Nb_{0.7}Zr_{0.3}OCl₄, Li_{1.5}Nb_{0.5}Zr_{0.5}OCl₄, Li_{1.7}Nb_{0.3}Zr_{0.7}OCl₄, or a combination thereof.

Example 14: The lithium ion conductor of any examples herein, particularly examples 1-13, wherein the lithium ion conductor has a lithium ion conductivity of from 1×10⁻⁵ SCm⁻¹ to 0.1 Scm⁻¹.

Example 15: The lithium ion conductor of any examples herein, particularly examples 1-14, wherein the lithium ion conductor has a lithium ion conductivity of from 0.2 to 50 mS/cm.

Example 16: A method of making the lithium ion conductor of any examples herein, particularly examples 1-15, wherein the method comprises a mechanochemical synthesis.

Example 17: The method of any examples herein, particularly example 16, wherein the method comprises combining a plurality of precursors to form a mixture and ball milling the mixture to form the lithium ion conductor.

Example 18: The method of any examples herein, particularly example 17, wherein the plurality of precursors comprise a niobium halide, a zirconium halide, and lithium hydroxide.

Example 19: The method of any examples herein, particularly example 17 or example 18, wherein the plurality of precursors comprise NbCl₅, ZrCl₄, and LiOH.

Example 20: The method of any examples herein, particularly examples 16-19, wherein the method comprises a two-step ball-milling method.

Example 21: The method of any examples herein, particularly example 20, wherein the two-step method comprises a first step followed by a second step, and the first step comprises planetary ball-milling and the second step comprises high-energy ball milling.

Example 22: The method of any examples herein, particularly examples 16-21, further comprising a post synthesis thermal treatment, for example to improve the crystallinity of the lithium ion conductor.

Example 23: A system comprising the lithium ion conductor of any examples herein, particularly examples 1-15.

Example 24: An article comprising the lithium ion conductor of any examples herein, particularly examples 1-15.

Example 25: A device comprising the lithium ion conductor of any examples herein, particularly examples 1-15.

Example 26: The device of any examples herein, particularly example 25, wherein the device is an energy storage device, such as a battery.

Example 27: The device of any examples herein, particularly example 25 or example 26, wherein the device is a battery, such as a solid state battery.

Example 28: A solid state battery comprising: a halide solid state electrolyte layer, the halide solid state electrolyte layer being a layer comprising a first halide solid state electrolyte, wherein the first halide solid state electrolyte is the lithium ion conductor of any examples herein, particularly examples 1-15; and a composite cathode; wherein the halide solid state electrolyte layer is disposed on and in contact with the composite cathode; wherein the composite cathode comprises a cathode active material, a conductive additive, and an electrolyte; wherein the electrolyte comprises: a plurality of particles comprising a second halide solid state electrolyte; or a liquid electrolyte, a polymer electrolyte, and/or a gel electrolyte.

Example 29: The solid state battery of any examples herein, particularly example 28, further comprising an anode, wherein the halide solid state electrolyte layer is sandwiched between and in contact with the anode and the composite cathode.

Example 30: A solid state battery comprising: an anode; a halide solid state electrolyte layer, the halide solid state electrolyte layer being a layer comprising a first halide solid state electrolyte, wherein the first halide solid state electrolyte is the lithium ion conductor of any examples herein, particularly examples 1-15; and a composite cathode; wherein the halide solid state electrolyte layer is sandwiched between and in contact with the anode and the composite cathode; wherein the composite cathode comprises a cathode active material, a conductive additive, and an electrolyte; wherein the electrolyte comprises: a plurality of particles comprising a second halide solid state electrolyte; or a liquid electrolyte, a polymer electrolyte, and/or a gel electrolyte.

Example 31: The solid state battery of any examples herein, particularly example 30, wherein the lithium ion conductor comprises Li₁₊ₓNb₁₋ₓZrₓOX₄, wherein X is a halide (e.g., F, Cl, Br, I, or a combination thereof) and x is from 0.2 to 0.7.

Example 32: The solid state battery of any examples herein, particularly example 31, wherein X is Cl.

Example 33: The solid state battery of any examples herein, particularly examples 30-32, further comprising an interfacial layer comprising an interfacial material, wherein: the interfacial layer is sandwiched between and in contact with the anode and the halide solid state electrolyte layer; the halide solid state electrolyte layer is sandwiched between and in contact with the interfacial layer and the composite cathode; the anode, the interfacial layer, the halide solid state electrolyte layer, and the composite cathode each has an electrochemical stability window; and the electrochemical stability window of the interfacial layer overlaps with that of the halide solid state electrolyte layer and the anode.

Example 34: A solid state battery comprising: an anode; an interfacial layer comprising an interfacial material; a halide solid state electrolyte layer, the halide solid state electrolyte layer being a layer comprising a first halide solid state electrolyte, wherein the first halide solid state electrolyte is the lithium ion conductor of any examples herein, particularly examples 1-15; and a composite cathode; wherein the interfacial layer is sandwiched between and in contact with the anode and the halide solid state electrolyte layer; wherein the halide solid state electrolyte layer is sandwiched between and in contact with the interfacial layer and the composite cathode; wherein the anode, the interfacial layer, the halide solid state electrolyte layer, and the composite cathode each has an electrochemical stability window; wherein the electrochemical stability window of the interfacial layer overlaps with that of the halide solid state electrolyte layer and the anode; and wherein the composite cathode comprises a cathode active material, a conductive additive, and an electrolyte; wherein the electrolyte comprises: a plurality of particles comprising a second halide solid state electrolyte; or a liquid electrolyte, a polymer electrolyte, and/or a gel electrolyte.

Example 35: The solid state battery of any examples herein, particularly example 33 or example 34, wherein the lithium ion conductor comprises Li₁₊ₓNb₁₋ₓZrₓOX₄, wherein X is a halide (e.g., F, Cl, Br, I, or a combination thereof) and x is from 0.5 to 0.95.

Example 36: The solid state battery of any examples herein, particularly example 35, wherein X is Cl.

Example 37: The solid state battery of any examples herein, particularly examples 33-36, wherein the interfacial layer has an average thickness of from 1 nanometer (nm) to 100 micrometers (microns, km).

Example 38: The solid state battery of any examples herein, particularly examples 33-37, wherein the interfacial layer has an average thickness of from 100 nanometers (nm) to 20 micrometers (microns, km).

Example 39: The solid state battery of any examples herein, particularly examples 33-38, wherein the interfacial layer has an ionic conductivity of lithium of from 1×10⁻⁸ Scm⁻¹ to 0.1 Scm⁻¹.

Example 40: The solid state battery of any examples herein, particularly examples 33-39, wherein the interfacial material comprises Li₆PS₅X (where X is Cl, Br, or I), Li₇P₃S₁₁ (LPS), garnet Li₇La₃Zr₂O₁₂ (LLZO), Li₃ₓLa_{2/3-x}TiO₃ (lithium lanthanum titanate (LLTO) perovskite), Li₃N, Li₃P, Li₃PS₄, LiBH₄, Li₂₊₂ₓZn₁₋ₓGeO₄, Li₁₊ₓAlₓTi₂₋ₓ(PO₄)₃ (LATP), Li₁₊ₓAlₓGe₂₋ₓ(PO₄)₃ (LAGP), Li₁₀GeP₂S₁₂ (LGPS), derivatives thereof (e.g., doped versions thereof), or a combination thereof.

Example 41: The solid state battery of any examples herein, particularly examples 33-40, wherein the interfacial material comprises Li₆PS₅Cl (LPSCl), Li₇P₃S₁₁ (LPS), garnet Li₇La₃Zr₂O₁₂ (LLZO), Li₃N, Li₃PS₄, Li₃P, or a combination thereof.

Example 42: The solid state battery of any examples herein, particularly examples 33-41, wherein the interfacial material comprises Li₆PS₅Cl (LPSCl), Li₇P₃S₁₁ (LPS), garnet Li₇La₃Zr₂O₁₂ (LLZO), Li₃PS₄, or a combination thereof.

Example 43: The solid state battery of any examples herein, particularly examples 33-42, wherein the interfacial material comprises Li₆PS₅Cl (LPSCl).

Example 44: The solid state battery of any examples herein, particularly examples 33-43, wherein the interfacial layer comprises a plurality of particles of the interfacial material.

Example 45: The solid state battery of any examples herein, particularly example 44, wherein the plurality of particles of the interfacial material have an average particle size of from 1 nanometer (nm) to 25 micrometers (microns, μm).

Example 46: The solid state battery of any examples herein, particularly example 44 or example 45, wherein the plurality of particles of the interfacial material have an average particle size of from 100 nanometers (nm) to 10 micrometers (microns, μm).

Example 47: The solid state battery of any examples herein, particularly examples 29-46, wherein the anode is formed in situ.

Example 48: The solid state battery of any examples herein, particularly examples 29-47, wherein the anode has a high capacity and/or a high energy density.

Example 49: The solid state battery of any examples herein, particularly examples 29-48, wherein the anode has a specific capacity of from 100 to 4000 mAh/g.

Example 50: The solid state battery of any examples herein, particularly examples 29-49, wherein the anode has a low intercalation voltage.

Example 51: The solid state battery of any examples herein, particularly examples 29-50, wherein the anode has an intercalation voltage of as 1 V or less versus Li⁺/Li⁰.

Example 52: The solid state battery of any examples herein, particularly examples 29-51, wherein the anode comprises a metal, an alloy, an intercalation material, or a combination thereof.

Example 53: The solid state battery of any examples herein, particularly examples 29-52, wherein the anode comprises lithium silicon, indium, graphite, hard carbon, or a combination thereof.

Example 54: The solid state battery of any examples herein, particularly examples 29-53, wherein the anode comprises lithium (e.g., lithium metal and/or a lithium alloy).

Example 55: The solid state battery of any examples herein, particularly examples 29-54, wherein the anode comprises lithium metal.

Example 56: The solid state battery of any examples herein, particularly examples 29-55, wherein the anode comprises a lithium alloy.

Example 57: The solid state battery of any examples herein, particularly examples 29-56, wherein the anode comprises a lithium-indium alloy, a lithium-magnesium alloy, a lithium-aluminum alloy, a lithium-iron alloy, or a combination thereof.

Example 58: The solid state battery of any examples herein, particularly examples 29-57, wherein the anode comprises a lithium-indium alloy.

Example 59: The solid state battery of any examples herein, particularly examples 29-58, wherein the anode comprises a composite (e.g., the anode is a composite anode).

Example 60: The solid state battery of any examples herein, particularly example 59, wherein the composite anode further includes a binder.

Example 61: The solid state battery of any examples herein, particularly example 60, wherein the binder comprises a polyethylene oxide (PEO), polyvinylidene fluoride (PVDF), polytetrafluoroethylene (PTFE), cellulose, carboxymethylcellulose (CMC), styrene-butadiene rubber (SBR), polyacrylic acid (PAA), polyvinyl alcohol (PVA), polyvinyl butyral (PVB), polyvinylpyrrolidone (PVP), ethyl cellulose (EC), copolymers thereof, derivatives thereof, or a combination thereof.

Example 62: The solid state battery of any examples herein, particularly examples 59-61, wherein the composite anode further includes a conductive additive.

Example 63: The solid state battery of any examples herein, particularly example 62, wherein the conductive additive comprises a carbon black, a modified carbon black, a graphene, a multi-layer graphene, carbon fibers, carbon nanotubes, carbon nanospheres, graphite, a reduced graphene oxide, or a combination thereof.

Example 64: The solid state battery of any examples herein, particularly example 62 or example 63, wherein the conductive additive comprises carbon black.

Example 65: The solid state battery of any examples herein, particularly examples 29-64, wherein the anode comprises a prelithiated host structure (e.g., a prelithiated silicon anode, a prelithiated silicon-graphite composite anode, a prelithiated graphite, a prelithiated hard carbon, etc.), a silicon-graphite composite anode, or a combination thereof.

Example 66: The solid state battery of any examples herein, particularly examples 28-65, wherein the halide solid state electrolyte layer has an average thickness of from 1 to 100 micrometers (microns, μm).

Example 67: The solid state battery of any examples herein, particularly examples 28-66, wherein the halide solid state electrolyte layer comprises a plurality of particles of the first halide solid state electrolyte.

Example 68: The solid state battery of any examples herein, particularly example 67, wherein the plurality of particles of the first halide solid state electrolyte have an average particle size of from 1 nanometer (nm) to 100 micrometers (microns, μm).

Example 69: The solid state battery of any examples herein, particularly example 67 or example 68, wherein the plurality of particles of the first halide solid state electrolyte have an average particle size of from 100 nanometers to 20 micrometers.

Example 70: The solid state battery of any examples herein, particularly examples 28-69, wherein the electrochemical stability window of the halide solid state electrolyte is compatible with the electrochemical stability window of the composite cathode.

Example 71: The solid state battery of any examples herein, particularly examples 28-70, wherein the cathode active material comprises a high density nickel-rich layered transition metal oxide (e.g., Li[NiₓMn_{y}Co_{z}]O₂ (x+y+z=1)), LiFe₁₋ₓMnₓPO₄ (LMFP), a lithium iron phosphate (LFP, LiFePO₄), lithium manganese oxide (LiMn₂O₄), nickel-doped lithium manganese oxide (Li[Ni_{0.5}Mn_{1.5}]O₄), LiCoO₂, LiNiO₂, or a combination thereof.

Example 72: The solid state battery of any examples herein, particularly examples 28-71, wherein the cathode active material comprises Li[NiₓMn_{y}Co_{z}]O₂ where x+y+z=1, LiFePO₄, or a combination thereof.

Example 73: The solid state battery of any examples herein, particularly examples 28-72, wherein the conductive additive comprises a carbon black, a modified carbon black, a graphene, a multi-layer graphene, carbon fibers, carbon nanotubes, carbon nanospheres, graphite, a reduced graphene oxide, or a combination thereof.

Example 74: The solid state battery of any examples herein, particularly examples 28-73, wherein the conductive additive comprises carbon black.

Example 75: The solid state battery of any examples herein, particularly examples 28-74, wherein the composite cathode further comprises a binder.

Example 76: The solid state battery of any examples herein, particularly example 75, wherein the binder comprises a polyethylene oxide (PEO), polyvinylidene fluoride (PVDF), polytetrafluoroethylene (PTFE), cellulose, carboxymethylcellulose (CMC), styrene-butadiene rubber (SBR), polyacrylic acid (PAA), polyvinyl alcohol (PVA), polyvinyl butyral (PVB), polyvinylpyrrolidone (PVP), ethyl cellulose (EC), copolymers thereof, derivatives thereof, or a combination thereof.

Example 77: The solid state battery of any examples herein, particularly examples 28-76, wherein the solid state battery is an all solid state battery.

Example 78: The solid state battery of any examples herein, particularly example 77, wherein the electrolyte of the composite cathode is a plurality of particles comprising a second halide solid state electrolyte.

Example 79: The solid state battery of any examples herein, particularly example 78, wherein the second halide solid state electrolyte has an ionic conductivity of lithium of from 1×10⁻⁶ SCm⁻¹ to 1 SCm⁻¹.

Example 80: The solid state battery of any examples herein, particularly example 78 or example 79, wherein the second halide solid state electrolyte comprises a lithium halide, a sodium halide, or a combination thereof.

Example 81: The solid state battery of any examples herein, particularly examples 78-80, wherein the second halide solid state electrolyte comprises a lithium halide.

Example 82: The solid state battery of any examples herein, particularly examples 78-81, wherein the second halide solid state electrolyte comprises the lithium ion conductor of any examples herein, particularly examples 1-15.

Example 83: The solid state battery of any examples herein, particularly examples 78-81, wherein the second halide solid state electrolyte comprises Li_{3-z}M^{[III+z]}X₆, where X is one or more halides, z is an integer from −2 to 2, and [III+z] represents the valence of the M-ion(s) in the compound.

Example 84: The solid state battery of any examples herein, particularly examples 78-82, wherein the second halide solid state electrolyte and the first halide solid state electrolyte are the same.

Example 85: The solid state battery of any examples herein, particularly examples 78-83, wherein the second halide solid state electrolyte and the first halide solid state electrolyte are different.

Example 86: The solid state battery of any examples herein, particularly examples 78-85, wherein the plurality of particles of second halide solid state electrolyte have an average particle size of from 1 nanometer (nm) to 50 micrometers (microns, μm).

Example 87: The solid state battery of any examples herein, particularly examples 78-86, wherein the plurality of particles of second halide solid state electrolyte have an average particle size of from 100 nanometers to 20 micrometers.

Example 88: The solid state battery of any examples herein, particularly examples 78-87, wherein the average particle size of the plurality of particles of the first halide solid state electrolyte and the average particle size of the plurality of particles of the second halide solid state electrolyte are the same.

Example 89: The solid state battery of any examples herein, particularly examples 78-87, wherein the average particle size of the plurality of particles of the first halide solid state electrolyte and the average particle size of the plurality of particles of the second halide solid state electrolyte are different.

Example 90: The solid state battery of any examples herein, particularly examples 28-76, wherein the solid state battery is a pseudo solid state battery.

Example 91: The solid state battery of any examples herein, particularly example 90, wherein the electrolyte of the composite cathode is a liquid electrolyte, a polymer electrolyte, and/or a gel electrolyte.

Example 92: The solid state battery of any examples herein, particularly examples 28-91, wherein the solid state battery further comprises a first current collector, wherein: when the anode is present, the anode is sandwiched between and in contact with the first current collector and the interfacial layer (when present) or the halide solid state electrolyte layer (when the interfacial layer is absent); and when the anode is absent, the first current collector is in contact with the interfacial layer (when present) or the halide solid state electrolyte layer (when the interfacial layer is absent).

Example 93: The solid state battery of any examples herein, particularly examples 28-92, wherein the solid state battery further comprises a second current collector, wherein the cathode is sandwiched between and in contact with the second current collector and the halide solid state electrolyte layer.

Example 94: The solid state battery of any examples herein, particularly example 92 or example 93, wherein the first current collector and/or the second current collector (when present) independently comprise a metal, a carbon material, or a combination thereof.

Example 95: The solid state battery of any examples herein, particularly examples 28-94, wherein the solid state battery further includes a casing that at least partially surrounds and/or encloses a cell comprising the anode (when present), the interfacial layer (when present), the halide solid state electrolyte layer, the composite cathode, the first current collector (when present), and the second current collector (when present).

Example 96: The solid state battery of any examples herein, particularly example 95, wherein the casing comprises a polymer, a metal, an alloy, a polymer coated metal foil, or a combination thereof.

Example 97: The solid state battery of any examples herein, particularly examples 28-96, wherein the anode is substantially free of dendrites during a plating/stripping cycle of operation of the solid state battery.

Example 98: The solid state battery of any examples herein, particularly examples 28-97, wherein the interfacial layer is substantially free of dendrites during a plating/stripping cycle of operation of the solid state battery.

Example 99: The solid state battery of any examples herein, particularly examples 28-98, wherein the solid state battery exhibits an energy density of from 75 Wh/kg to 600 Wh/kg.

Example 100: The solid state battery of any examples herein, particularly examples 28-99, wherein the solid state battery exhibits a specific discharge capacity of from 100 mA h/g to 400 mA h/g when discharged at a rate of from 0.1 C to 10 C.

Example 101: The solid state battery of any examples herein, particularly examples 28-100, wherein the solid state battery is rechargeable.

Example 102: The solid state battery of any examples herein, particularly examples 28-101, wherein the solid state battery exhibits a coulombic efficiency of 80% or more for 100 cycles or more.

Example 103: The solid state battery of any examples herein, particularly examples 28-102, wherein the solid state battery exhibits a coulombic efficiency of 99% or more for 100 cycles or more.

Example 104: The solid state battery of any examples herein, particularly examples 28-103, wherein the solid state battery exhibits a capacity retention of 80% or more for 100 cycles or more.

Example 105: The solid state battery of any examples herein, particularly examples 28-104, wherein the solid state battery exhibits a capacity retention of 90% or more for 100 cycles or more.

Example 106: A method of making the solid state battery of any examples herein, particularly examples 28-105.

Example 107: The method of any examples herein, particularly example 106, wherein the method comprises a dry chemical process in which the cathode and anode are produced separately and the halide solid state electrolyte material and the interfacial layer (when present) are produced as freestanding films or membranes and the entire cell is sandwiched together.

Example 108: A system comprising one or more of the solid state batteries of any examples herein, particularly examples 28-105.

Example 109: The system of any examples herein, particularly example 108, wherein the system is an energy storage system.

Example 110: An article comprising one or more of the solid state batteries of any examples herein, particularly examples 28-105.

Example 111: The article of any examples herein, particularly example 110, wherein the article is a vehicle, such as a hybrid electric vehicle or an all-electric vehicle.

Example 112: The article of any examples herein, particularly example 110, wherein the article comprises an electronic device, such as a portable electronic device, a laptop, a watch, or a cell phone.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The methods of the appended claims are not limited in scope by the specific methods described herein, which are intended as illustrations of a few aspects of the claims and any methods that are functionally equivalent are intended to fall within the scope of the claims. Various modifications of the methods in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

What is claimed is:

1. A lithium ion conductor comprising a compound of Formula I:
Li₁₊ₓNb₁₋ₓZrₓOX₄ I
wherein
X is a halide; and
x is from greater than 0 to less than 1.

2. The lithium ion conductor of claim 1, wherein x is from 0.05 to 0.95.

3. The lithium ion conductor of claim 1, wherein x is from 0.2 to 0.95.

4. The lithium ion conductor of claim 1, wherein x is from 0.2 to 0.7.

5. The lithium ion conductor of claim 1, wherein x is from 0.5 to 0.95.

6. The lithium ion conductor of claim 1, wherein X is Cl.

7. The lithium ion conductor of claim 1, wherein the lithium ion conductor comprises Li_{1.1}Nb_{0.9}Zr_{0.10}Cl₄, Li_{1.3}Nb_{0.7}Zr_{0.3}OCl₄, Li_{1.5}Nb_{0.5}Zr_{0.5}OCl₄, Li_{1.7}Nb_{0.3}Zr_{0.7}OCl₄, Li_{1.9}Nb_{0.1}Zr_{0.9}OCl₄, or a combination thereof.

8. The lithium ion conductor of claim 1, wherein the lithium ion conductor has a lithium ion conductivity of from 1×10⁻⁵ SCm⁻¹ to 0.1 SCm⁻¹.

9. The lithium ion conductor of claim 1, wherein the lithium ion conductor has a lithium ion conductivity of from 0.2 to 50 mS/cm.

10. A method of making the lithium ion conductor of claim 1, wherein the method comprises a mechanochemical synthesis.

11. The method of claim 10, wherein the method comprises combining a plurality of precursors to form a mixture and ball milling the mixture to form the lithium ion conductor.

12. A device comprising the lithium ion conductor of claim 1, wherein the device is an energy storage device.

13. The device of claim 12, wherein the device is a solid state battery.

14. A solid state battery comprising:
a halide solid state electrolyte layer, the halide solid state electrolyte layer being a layer comprising a first halide solid state electrolyte, wherein the first halide solid state electrolyte is the lithium ion conductor of claim 1; and
a composite cathode;
wherein the halide solid state electrolyte layer is disposed on and in contact with the composite cathode;
wherein the composite cathode comprises a cathode active material, a conductive additive, and an electrolyte;
wherein the electrolyte comprises:
a plurality of particles comprising a second halide solid state electrolyte; or
a liquid electrolyte, a polymer electrolyte, and/or a gel electrolyte.

15. The solid state battery of claim 14, further comprising an anode, wherein the halide solid state electrolyte layer is sandwiched between and in contact with the anode and the composite cathode.

16. A solid state battery comprising:
an anode;
a halide solid state electrolyte layer, the halide solid state electrolyte layer being a layer comprising a first halide solid state electrolyte, wherein the first halide solid state electrolyte is the lithium ion conductor of claim 1; and
a composite cathode;
wherein the halide solid state electrolyte layer is sandwiched between and in contact with the anode and the composite cathode;
wherein the composite cathode comprises a cathode active material, a conductive additive, and an electrolyte;
wherein the electrolyte comprises:
a plurality of particles comprising a second halide solid state electrolyte; or
a liquid electrolyte, a polymer electrolyte, and/or a gel electrolyte.

17. The solid state battery of claim 16, wherein the lithium ion conductor comprises Li₁₊ₓNb₁₋ₓZrₓOX₄, wherein X is a halide and x is from 0.2 to 0.7.

18. The solid state battery of claim 17, wherein X is Cl.

19. The solid state battery of claim 16, further comprising an interfacial layer comprising an interfacial material, wherein:
the interfacial layer is sandwiched between and in contact with the anode and the halide solid state electrolyte layer;
the halide solid state electrolyte layer is sandwiched between and in contact with the interfacial layer and the composite cathode;
the anode, the interfacial layer, the halide solid state electrolyte layer, and the composite cathode each has an electrochemical stability window; and
the electrochemical stability window of the interfacial layer overlaps with that of the halide solid state electrolyte layer and the anode.

20. A solid state battery comprising:
an anode;
an interfacial layer comprising an interfacial material;
a halide solid state electrolyte layer, the halide solid state electrolyte layer being a layer comprising a first halide solid state electrolyte, wherein the first halide solid state electrolyte is the lithium ion conductor of claim 1; and
a composite cathode;
wherein the interfacial layer is sandwiched between and in contact with the anode and the halide solid state electrolyte layer;
wherein the halide solid state electrolyte layer is sandwiched between and in contact with the interfacial layer and the composite cathode;
wherein the anode, the interfacial layer, the halide solid state electrolyte layer, and the composite cathode each has an electrochemical stability window;
wherein the electrochemical stability window of the interfacial layer overlaps with that of the halide solid state electrolyte layer and the anode; and
wherein the composite cathode comprises a cathode active material, a conductive additive, and an electrolyte;
wherein the electrolyte comprises:
a plurality of particles comprising a second halide solid state electrolyte; or
a liquid electrolyte, a polymer electrolyte, and/or a gel electrolyte.
